(19) United States
(12) Patent Application Publication
(10) Pub. No.: US 2013/0080604 A1
(43) Pub. Date: Mar. 28, 2013

(54) SYSTEM MANAGEMENT APPARATUS AND SYSTEM MANAGEMENT METHOD

(71) Applicants: Hiroshi Hayakawa, Yokohama (JP); Takeshi Arisaka, Yokohama (JP); Takaki Kuroda, Machida (JP); Takumi Tomita, Yokohama (JP)

(72) Inventors: Hiroshi Hayakawa, Yokohama (JP); Takeshi Arisaka, Yokohama (JP); Takaki Kuroda, Machida (JP); Takumi Tomita, Yokohama (JP)

(73) Assignee: HITACHI, LTD., Tokyo (JP)

(21) Appl. No.: 13/378,066

(22) PCT Filed: Sep. 22, 2011
(86) PCT No.: PCT/JP11/71736

§ 371 Date: Dec. 14, 2011

(51) Int. Cl. G06F 15/177

(52) U.S. Cl. 709/220

(57) ABSTRACT

The present invention is for efficiently managing large numbers of apparatuses using multiple management protocols. A management information acquisition part 1A uses multiple different management protocols P1 and P2 to acquire management information for each of the management protocols from each apparatus 3. Anode configuration information management part 1B identifies apparatus configuration information acquired from the same apparatus of the respective apparatuses 3 by comparing the apparatus configuration information, and collectively manages these multiple pieces of apparatus configuration information as a single piece of apparatus configuration information. A component information management part 1C identifies multiple pieces of component information related to the same component, and manages these identified multiple pieces of component information after associating these pieces information with each other.

### TECHNICAL FIELD

The present invention relates to a system management apparatus and a system management method.

### BACKGROUND ART

For example, a data center or other such information processing system comprises a large number of server computers, a large number of storage apparatuses, and a large number of network apparatuses. A computer system for managing an information processing system comprising large numbers of apparatuses is known (Patent Literature 1).

### CITATION LIST

### Patent Literature

### [PTL 1]

Japanese Patent Application Laid-open No. 2009-169863

### SUMMARY OF INVENTION

### Technical Problem

The large numbers of apparatuses comprising the information processing system also include numerous apparatuses that support multiple different management protocols and are able to respond to queries from the respective management protocols.

As protocols for managing an apparatus, for example, WMI (Windows Management Interface), SSH (Secure SHell), SNMP (Simple Network Management Protocol), and IPMI (Intelligent Platform Management Interface) are known.

An apparatus that supports multiple management protocols, because it respectively responds to each management protocol, is detected as being multiple different apparatuses despite the fact that physically it is in the same enclosure. Therefore, large numbers of duplicate pieces of management information are created, system management becomes complicated for the administrator, and the efficiency of management work declines. In addition, events resulting from the same cause are detected as different individual events by each management protocol, thereby making it difficult to discern the root cause of a failure when one occurs.

Furthermore, the prior art disclosed in the above-mentioned literature manages a combination of one component and another component as a new component, and does not eliminate the redundancy of the information acquired from the same apparatus in accordance with different individual management protocols.

With the foregoing in view, an object of the present invention is to provide a system management apparatus and a system management method that make it possible to determine whether information acquired in accordance with multiple different management protocols is information from the same apparatus, and to reduce management time and trouble. Another object of the present invention is to provide a system management apparatus and a system management method that make it possible to determine whether information has been acquired from the same apparatus based on unique information and monitoring information obtained from the apparatus.

### Solution to Problem

A system management apparatus related to one aspect of the present invention manages an information processing system having multiple apparatuses, and comprises a management information acquisition part for acquiring management information for each management protocol from each apparatus, an apparatus configuration information management part for identifying multiple pieces of apparatus configuration information, which have been acquired from the same apparatus among respective apparatuses by comparing apparatus configuration information obtained from each piece of management information, and collectively managing these identified multiple pieces of apparatus configuration information as a single piece of apparatus configuration information, and a component information management part for identifying multiple pieces of component information related to the same component from among component information included in multiple pieces of apparatus configuration information identified as having been acquired from the same apparatus, and correspondingly managing these identified multiple pieces of component information.

The apparatus configuration information management part comprises an automatic mode, and an apparatus configuration information management part, which is operating in the automatic mode, is able to identify multiple pieces of apparatus configuration information acquired from the same apparatus among respective apparatuses by comparing respective pieces of apparatus configuration information on the basis of a merge rule stored beforehand in a merge rule management table.

The merge rule may comprise a first decision rule for deciding that one piece of apparatus configuration information and the other piece of apparatus configuration information are pieces of apparatus configuration information acquired from the same apparatus in a case where one piece of unique information included in the one piece of apparatus configuration information of the respective pieces of apparatus configuration information matches the other piece of unique information included in the other piece of apparatus configuration information of the respective pieces of apparatus configuration information, and a second decision rule for deciding that one piece of apparatus configuration information obtained from one piece of management information and the other piece of apparatus configuration information obtained from the other piece of management information are pieces of apparatus configuration information acquired from the same apparatus in a case where one piece of monitoring information, which is included in the one piece of management information of respective pieces of management information and shows either a performance or a status monitoring result for an apparatus corresponding to the one piece of management information, matches within a prescribed range the other piece of monitoring information, which is included in the other piece of management information of the respective pieces of management information and shows either a performance or a status monitoring result for an apparatus corresponding to the other piece of management information.

The apparatus configuration information management part can also initially identify multiple pieces of apparatus configuration information acquired from the same apparatus in accordance with the first decision rule, and in a case where an identification could not be made using the first decision rule, can identify multiple pieces of apparatus configuration information acquired from the same apparatus in accordance with the second decision rule.

The apparatus configuration information management part can also determine whether or not each piece of apparatus configuration information identified as having been acquired from the same apparatus satisfies an essential requirement rule, which has been stored beforehand in an essential requirement rule table, and in a case where each piece of apparatus configuration information satisfies the essential requirement rule, can determine that each piece of apparatus configuration information has been acquired from the same apparatus.

The apparatus configuration information management part comprises a manual mode, and the essential requirement rule, which must be satisfied in a case where the multiple pieces of apparatus configuration information have been acquired from the same apparatus, is configured beforehand in an essential requirement rule management table, and when operating in the manual mode, the apparatus configuration information management part is able to determine that each piece of apparatus configuration information has been acquired from the same apparatus in a case where a screen listing each piece of apparatus configuration information has been provided to the user, a decision has been made as to whether or not multiple pieces of apparatus configuration information selected by the user by way of the list screen satisfy the essential requirement rule, and each piece of apparatus configuration information selected by the user satisfies the essential requirement rule.

### BRIEF DESCRIPTION OF DRAWINGS

FIG. 1 is a schematic diagram showing an overview of the entire embodiment.

FIG. 2 shows the overall configuration of an information processing system and the hardware configurations of a management computer and a client computer.

FIG. 3 is a schematic diagram showing computer programs and tables stored in the memory of the management computer.

FIG. 4 shows the hardware configuration of a server computer.

FIG. 5 shows the hardware configuration of a storage apparatus.

FIG. 6 shows the hardware configuration of a network apparatus.

FIG. 7 shows the configuration of a coupling information management table.

FIG. 8 shows the configuration of an authentication information management table.

FIG. 9 shows the configuration of an apparatus configuration information management table.

FIG. 10 shows an example of a component information management table.

FIG. 11 shows another example of a component information management table.

FIG. 12 shows yet another example of a component information management table.

FIG. 13 shows an example of a monitoring value history management table.

FIG. 14 shows another example of a monitoring value history management table.

FIG. 15 shows yet another example of a monitoring value history management table.

FIG. 16 shows the configuration of a merge rule management table.

FIG. 17 shows the configuration of an essential requirement rule management table.

FIG. 18 shows the configuration of an aggregation rule management table.

FIG. 19 is a flowchart of a process for acquiring management information.

FIG. 20 is a flowchart of a process for acquiring a monitoring value.

FIG. 21 is a flowchart of an automatic merge process.

FIG. 22 is a flowchart of a process for supporting a manual merge.

FIG. 23 is a flowchart of a process for evaluating a merge rule.

FIG. 24 is a flowchart of a process for evaluating an essential requirement rule.

FIG. 25 is a flowchart of a process for expanding an evaluation formula.

FIG. 26 is a schematic diagram showing an example of the expansion of the evaluation formula.

FIG. 27 is a schematic diagram showing another example of the expansion of the evaluation formula.

FIG. 28 is a flowchart of a merge process.

FIG. 29 is a flowchart showing a process for aggregating component information.

FIG. 30 is a flowchart of a process for evaluating an aggregation rule.

FIG. 31 shows an example of expanding an aggregation rule.

FIG. 32 is a flowchart of a process for creating display information.

FIG. 33 is an example of a screen for displaying a list of discovered apparatuses.

FIG. 34 is an example of a screen for supporting a manual merge.

FIG. 35 is an example of a screen for displaying apparatus information.

FIG. 36 is a flowchart of a process for supporting a manual merge executed by a system management apparatus related to a second example.

### DESCRIPTION OF THE EMBODIMENT

The embodiment of the present invention will be explained below by referring to the drawings. However, it should be noted that this embodiment is merely an example for realizing the present invention, and does not limit the technical scope of the present invention.

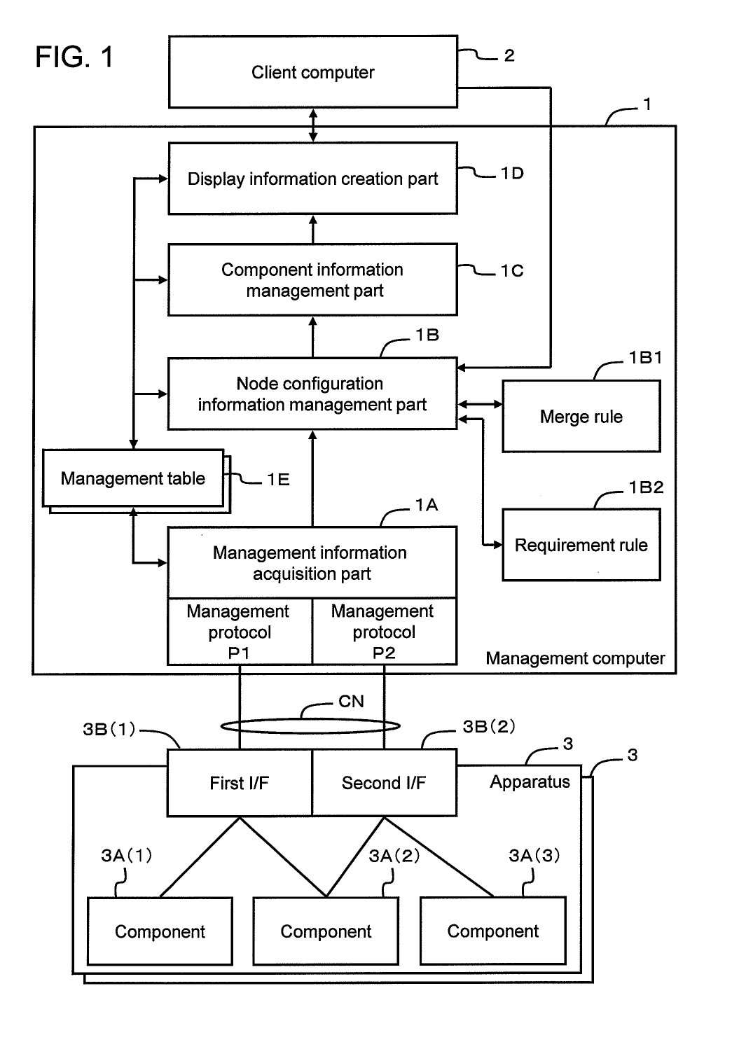

FIG. 1 shows an overview of this embodiment. The information processing system, for example, comprises a management computer 1, a client computer 2, and multiple apparatuses 3. The management computer 1 is coupled to each apparatus 3 via a communication network CN so as to enable two-way communications. In addition, the management computer 1 is coupled to the client computer 2 via either the communication network CN or another communication means so as to enable two-way communications.

The management computer 1 is an apparatus for managing the respective apparatuses 3. The management computer 1 and the client computer 2 comprise a “system management apparatus”. Or, the management computer 1 alone may comprise the “system management apparatus”. A user interface apparatus of the client computer 2 can also be disposed in the management computer 1.

The management computer 1, for example, comprises a management information acquisition part 1A, a node configuration information management part 1B, a component information management part 1C, a display information creation part 1D, and various management tables 1E, 1B1, and 1B2.

The management information acquisition part 1A acquires management information from each apparatus 3 using multiple management protocols P1 and P2. As the management protocols, for example, there are WMI, SSH, SNMP, and IPMI. Acquired management information is stored in a management table 1E.

Each apparatus 3 comprises respectively different multiple management interfaces 3B(1) and 3B(2). In the drawing, interface is abbreviated as I/F. In a case where no distinction is made, the management interfaces 3B(1) and 3B(2) will be called the management interface 3B. Each management interface 3B provides management information in response to a request from the respective corresponding management protocol.

The management information is information for management, which is acquired from an apparatus 3 and a component 3A that comprises an apparatus 3. The management information can include node configuration information, component information, and a monitoring value.

Not all of the apparatuses 3 need to support multiple management protocols. At least one apparatus 3, which supports multiple management protocols that differ from one another, may be included inside the information processing system. For example, a server computer equipped with an IPMI substrate may be included in the information processing system.

The node configuration information management part 1B is equivalent to an “apparatus configuration information management part”. The node configuration information management part 1B determines whether or not node configuration information respectively obtained from multiple pieces of management information acquired in accordance with different management protocols originated from the same apparatus. The node configuration information corresponds to “apparatus configuration information”. The node configuration information is created on the basis of management information acquired from an apparatus 3, and, for example, comprises a node type, a system GUID (Global Unique Identifier), a product serial number, and a monitoring value.

The node configuration information management part 1B determines whether multiple pieces of node configuration information originated from the same apparatus based on a merge rule, which is stored in a merge rule management table 1B1. The merge rule comprises a first decision rule and a second decision rule.

The first decision rule decides whether multiple pieces of node configuration information originated from the same apparatus based on unique information preconfigured in the apparatus 3. Unique information, for example, includes a system GUID, a product serial number, and a board serial number. The unique information is static information because it does not change after it is set to the apparatus 3.

In a case where it is not possible to make a decision using only the first decision rule, the node configuration information management part 1B decides whether the multiple pieces of node configuration information originate from the same apparatus based on a second decision rule.

The second decision rule compares pieces of monitoring information (the monitoring values described hereinbelow) acquired from an apparatus 3. As the monitoring information, for example, there is information showing the temperature of an apparatus 3. In a case where temperature information obtained from one piece of management information substantially matches temperature information obtained from another piece of management information, a decision can be made that the management information corresponding to these pieces of temperature information originated from the same apparatus. The monitoring information is dynamic information that changes over time.

The node configuration information management part 1B uses an essential requirement rule, which is stored in an essential requirement rule management table 1B2, to decide the suitability of a decision result based on the merge rule. The essential requirement rule stipulates information that is always expected to be present when management information originates from the same apparatus. For example, the essential requirement rule can include such things as the fact that system GUIDs are a match, and node types (apparatus types) are a match. In a case where all the conditions defined in the essential requirement rule have been satisfied, the node configuration information management part 1B regards the decision result based on the merge rule as being correct. The node configuration information management part 1B realizes fail-proof in accordance with an essential requirement rule-based check.

The node configuration information management part 1B comprises an automatic mode and a manual mode. In a case where the automatic mode has been selected, the node configuration information management part 1B automatically decides whether multiple pieces of node configuration information originated from the same apparatus based on the merge rule and the essential requirement rule. In a case where the manual mode has been selected, the node configuration information management part 1B receives a user-selected combination of node configuration information from the client computer 2. The node configuration information management part 1B decides whether or not the multiple pieces of node configuration information selected by the user satisfy the essential requirement rule, and when the rule is satisfied, regards the user selection as correct. The node configuration information management part 1B also comprises functions for supporting a manual operation by the user like this.

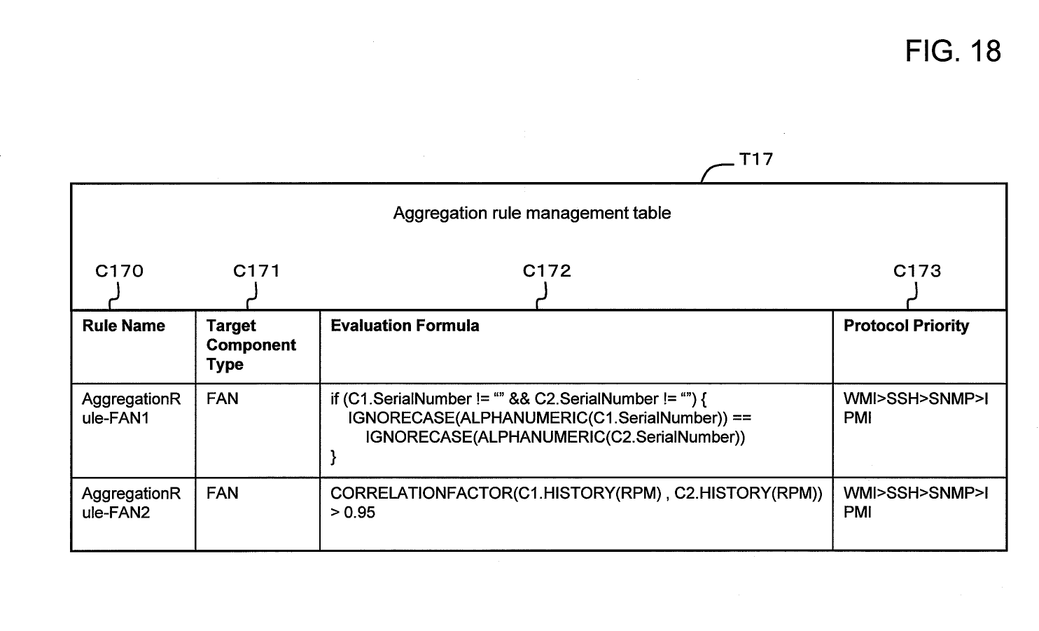

The component information management part 1C decides whether multiple pieces of component information originate from the same apparatus. The component information relates to a component 3A of an apparatus 3. The component information management part 1C decides whether multiple pieces of component information originate from the same apparatus based on a component merge rule (an aggregation rule management table T17 described in FIG. 18).

The node configuration information management part 1B only keeps prescribed node configuration information from among duplicate node configuration information, and deletes other node configuration information. The prescribed node configuration information is node configuration information created from management information acquired using a high-priority management protocol.

The component information management part 1C only provides the user with prescribed component information from among duplicate component information, and hides other component information from the user. However, even component information that is not provided to the user is stored rather than being deleted.

The display information creation part 1D creates display information, and displays this created information on a display device of the client computer 2. The display information can comprise node configuration information, which has been organized by the node configuration information management part 1B, and component information, which has been organized by the component information management part 1C.

The apparatus 3 is a node included in the information processing system, and, for example, can include a server computer, a storage apparatus, a network apparatus, a printer, a monitoring camera, a copying machine, and so forth.

The apparatus 3 comprises at least one and normally multiple components 3A(1) through 3A(3). When no distinction is made, the components 3A(1) through 3A(3) will be called the component 3A. The component 3A, for example, can include a cooling fan, a CPU (Central Processing Unit), a temperature sensor, and so forth. The type of component 3A will differ in accordance with the type of apparatus 3. Of the components 3A, which differ in accordance with the apparatus type, a component 3A that is relatively widely shared is the management target of the component information management part 1C.

Component 3A(1) and component 3A(2) are associated with the first management interface 3B(1), and component 3A(2) and component 3A(3) are associated with the second management interface 3B(2).

Therefore, a first management information, which is acquired from the first management interface 3B(1) in accordance with the first management protocol P1, and a second management information, which is acquired from the second management interface 3B(2) in accordance with the second management protocol P2, differ. This is because, whereas the first management information comprises information related to component 3A(1) and component 3A(2), the second management information comprises information related to component 3A(2) and component 3A(3). However, in this embodiment, management information (node configuration information and component information) originating from the same apparatus are detected and managed as a single piece of management information.

In this embodiment, which is configured in this manner, duplicate node configuration information originating from the same apparatus is detected and managed as a single piece of node configuration information, and, in addition, duplicate component information originating from the same apparatus is also managed as a single piece of component information. Therefore, the total number of pieces of information to be managed can be reduced, making it possible to efficiently manage an information processing system in which multiple apparatuses 3 corresponding to multiple management protocols exist.

In this embodiment, duplicate node configuration information can be automatically detected on the basis of the merge rule, enabling the administrator to save time and trouble. In addition, in this embodiment, since the suitability of a decision result based on the merge rule is checked on the basis of the essential requirement rule, the reliability of the decision result can be maintained.

In this embodiment, a check of a node configuration information combination selected by the user (system administrator) is conducted in accordance with the essential requirement rule. Therefore, a human error on the part of the user can be prevented, and usability and reliability can be enhanced.

In this embodiment, a first decision rule based on static unique information, and a second decision rule based on dynamic monitoring information are used as the merge rule. In addition, after making a decision on the basis of the first decision rule, a decision is made on the basis of the second decision rule. This enables highly accurate decisions to be efficiently made in this embodiment.

Carrying out a comparison based on unique information increases the accuracy of a decision as to whether or not information originated from the same apparatus more than a comparison based on monitoring information. However, depending on the type of management protocol, unique information may not be able to be acquired. A decision based on monitoring information is effective in a case where unique information cannot be used. However, comparing pieces of monitoring information increases the processing load.

Therefore, in this embodiment, a decision based on unique information, which is relatively simple to process and highly accurate, is executed initially, and after that, a decision based on monitoring information for which the processing load is high is executed. In this embodiment, preferentially executing a decision using unique information makes it possible to efficiently carry out a highly accurate decision.

In this embodiment, an essential requirement rule-based check is performed on a merge rule-based decision result. Therefore, an erroneous decision can be prevented. In addition, in this embodiment, an essential requirement rule-based check is also performed for a result that the user has selected manually. Therefore, a human error on the part of the user can be prevented, and management reliability can be enhanced.

In this embodiment, only prescribed component information from among multiple pieces of component information originating from the same apparatus is included in display information and outputted, and component information other than this is stored. Therefore, even in a case where a failure has occurred with respect to a management protocol related to the prescribed component information, the system can be managed on the basis of component information in accordance with another management protocol, making the realization of failsafe possible. This embodiment will be explained in more detail below.

### Example 1

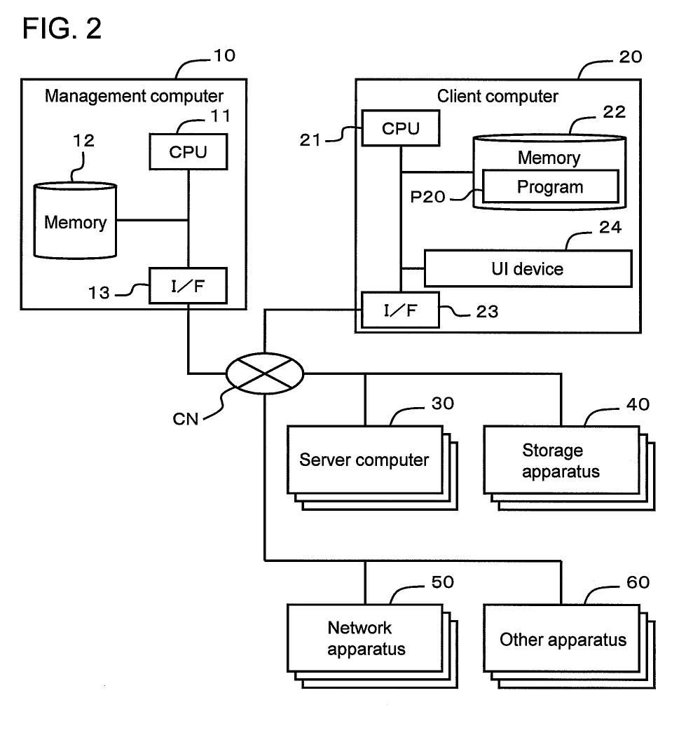

A first example will be explained by referring to FIGS. 2 through 35. First, the relationship with FIG. 1 will be described. A management computer 10 corresponds to the management computer 1, a client computer 20 corresponds to the client computer 2, and a server computer 30, a storage apparatus 40, a network apparatus 50, and another apparatus 60 correspond to the apparatus 3.

The management computer 10, for example, comprises a microprocessor (CPU in the drawing) 11, a memory 12, and a communication interface 13. The memory 12 is a component that represents a main storage and an auxiliary storage, and may be called a storage resource. The computer programs P10 through P19 and management tables T10 through T17 of the management computer 10 will be described further below. The management computer 10 is coupled to the client computer 20, the server computer 30, the storage apparatus 40, the network apparatus 50, and the other apparatus 60 via a communication network CN configured like a LAN (Local Area Network).

The client computer 20 is the computer via which the system administrator or other such user operates the management computer 10. The client computer 20, for example, comprises a microprocessor 21, a memory 22, a communication interface 23, and a user interface device 24.

The memory 22 stores a display program P20 for displaying screens G10, G11, and G12, which will be described further below, on the user interface device 24. The user can input instructions to the management computer 10 and can extract information from the management computer 10 by using the user interface device 24 to operate the display program P20.

The user interface device 24 comprises an information input device for inputting information, and an information output device for outputting information. The information input device, for example, may include a keyboard switch, a pointing device, a pen input device, and a voice recognition device. The information output device, for example, may include a display device, a printer, and an audio output device.

The explanation of this example will be divided between the management computer 10 and the client computer 20, but the configuration may also be such that a user interface part is disposed in the management computer 10. Furthermore, the client computer 20 is not limited to a computer terminal such as a personal computer, but rather may be a personal digital assistant (to include a mobile phone).

In this example, the server computer 30, the storage apparatus 40, the network apparatus 50, and the other apparatus 60 will be given as examples of management-target apparatuses of the management computer 10. The information processing system does not have to comprise all of these apparatuses 30 through 60, but rather may comprise at least one of at least any one type of apparatus.

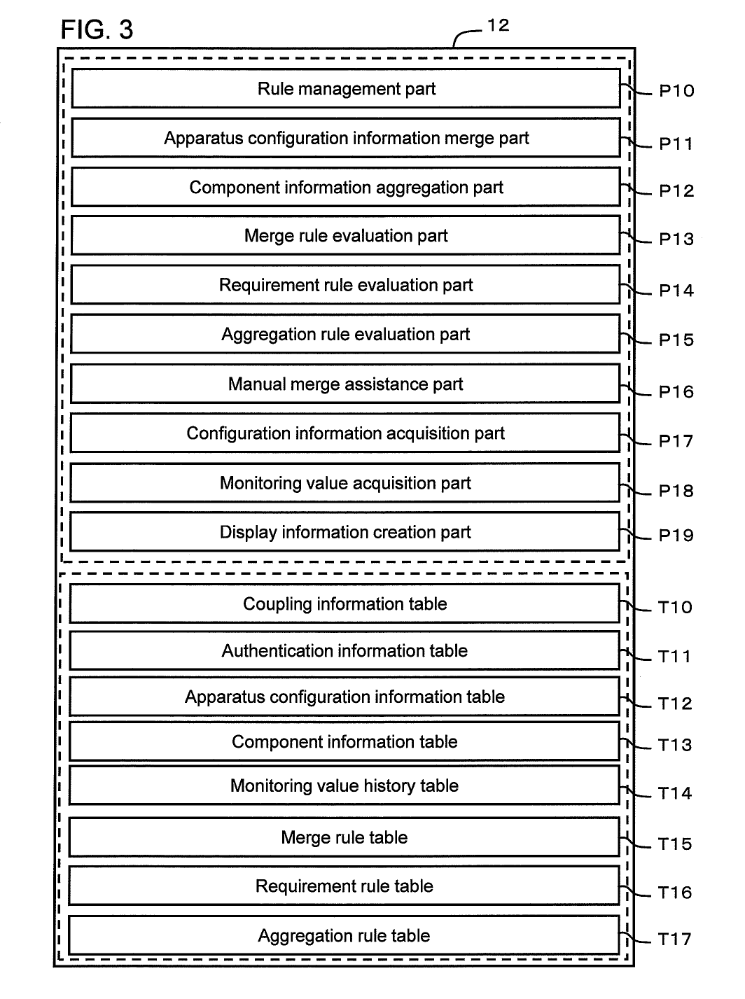

FIG. 3 shows computer programs and management tables stored in the memory 12 of the management computer 10. The memory 12 stores multiple computer programs P10 through P19, and multiple management tables T10 through T17. An operating system, device driver and other such computer programs have been omitted from the drawing.

The operation of the respective computer programs will be described further below by referring to flowcharts. An overview of the respective computer programs will be briefly explained here.

A rule management part P10 is a program for managing the merge rule, the essential requirement rule, and an aggregation rule. An apparatus configuration information merge part P11 is a program for gathering together duplicate apparatus configuration information originating from the same apparatus as a single piece of apparatus configuration information. A component information aggregation part P12 is a program for gathering together duplicate component information as a single piece of component information.

In this example, since only prescribed apparatus configuration information from among duplicate apparatus configuration information is kept and apparatus configuration information other than this is deleted, regarding multiple pieces of apparatus configuration information as a single piece of apparatus configuration information is called a “merge”.

Alternatively, only prescribed component information of duplicate component information is displayed, but component information other than this continues to be stored. Therefore, regarding multiple pieces of component information as a single piece of component information as seen from the user's perspective is called an “aggregation”.

However, other component information besides the prescribed component information need not be stored in a monitoring value history or the like. This is because this component information is used in a special situation such as when a failure occurs, and is not used under normal circumstances. Unused data can be prevented from accumulating in the storage area of the management computer 10 by not collecting and storing monitoring values and the like. That is, component information other than the prescribed component information from among the duplicate multiple pieces of component information continues to be recognized inside the management computer 10 in preparation for the occurrence of a failure, but data collection and storage can be suspended.

A merge rule evaluation part P13 is a program for evaluating a merge rule application result. An essential requirement rule evaluation part P14 is a program for evaluating an essential requirement rule application result. An aggregation rule evaluation part P15 is a program for evaluating an aggregation rule application result. A manual merge support part P16 is a program for deciding the suitability of a merge in accordance with a user manual operation.

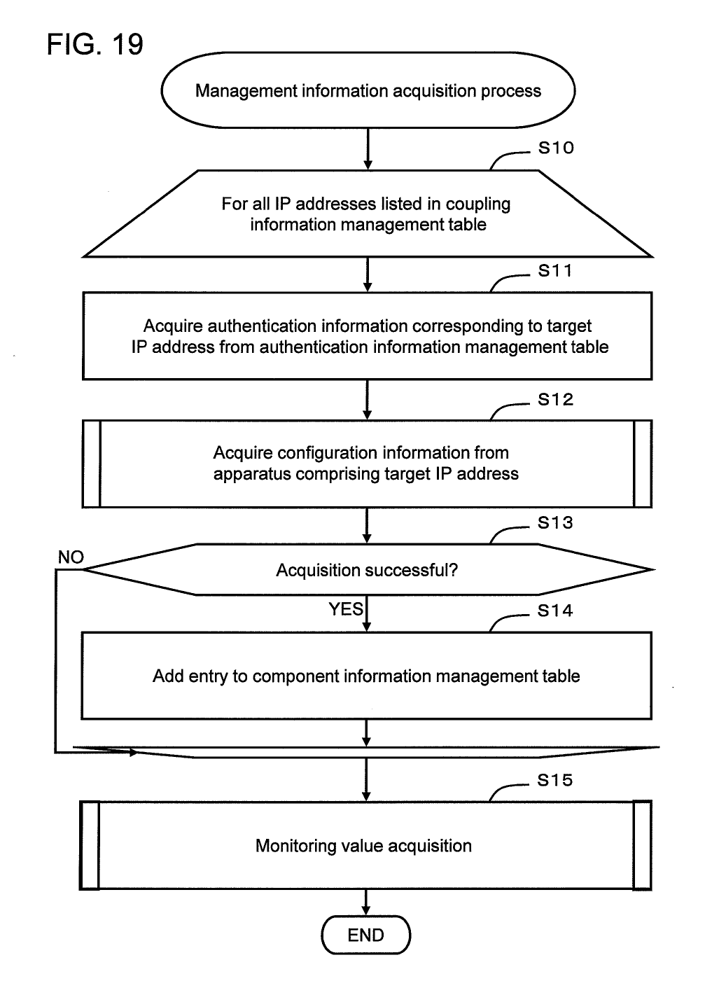

A configuration information acquisition part P17 is a program for acquiring configuration information from each apparatus 30 through 60. A monitoring value acquisition part P18 is a program for acquiring monitoring values from each apparatus 30 through 60. In a management information acquisition process, which will be described further below (refer to FIG. 19), the configuration information acquisition part P17 and the monitoring value acquisition part P18 are executed.

A display information creation part P19 is a program for creating display information and sending this information to the client computer 20.

An overview of the respective management tables 110 through 117 will be explained briefly. Examples of the configurations of the respective management tables T10 through T17 will be described further below. Furthermore, in FIG. 3, “management table” has been abbreviated and described as “table”.

A coupling information management table 110 manages information for the management computer 10 to access the respective apparatuses 30 through 60. An authentication information management table T11 manages information for the management computer 10 to log in to the respective apparatuses 30 through 60.

An apparatus configuration information management table T12 manages apparatus configuration information acquired from each apparatus 30 through 60. A component information management table T13 manages component information for a component included in each apparatus 30 through 60. A monitoring value history management table T14 manages a monitoring value (monitoring information) acquired from a component.

A merge rule management table T15 manages the merge rule. An essential requirement rule management table T16 manages the essential requirement rule. An aggregation rule management table T17 manages the aggregation rule.

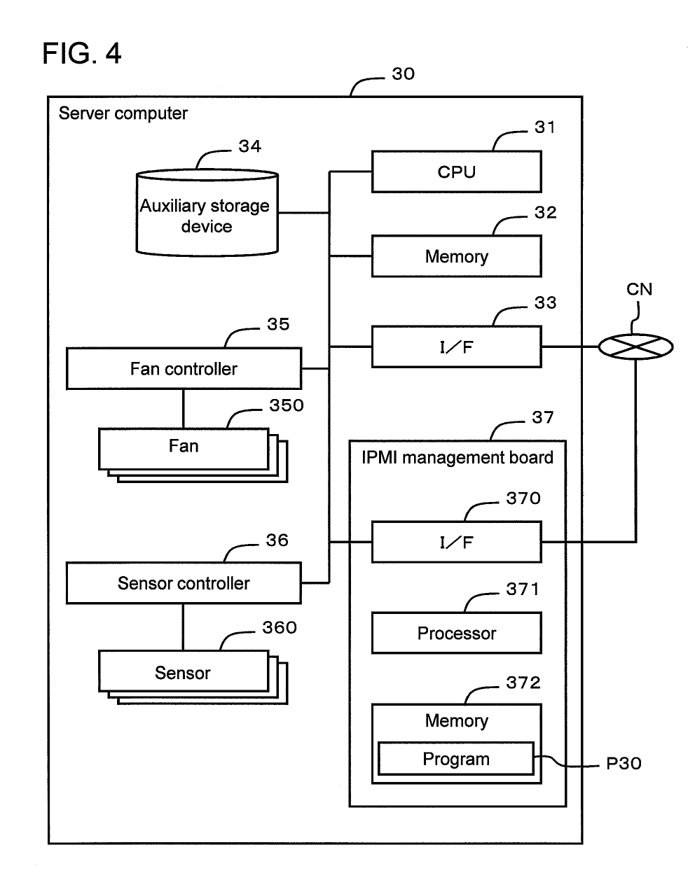

FIG. 4 shows the hardware configuration of a server computer 30, which is one of the management-target apparatuses. The server computer 30, for example, comprises a CPU 31, a memory 32, a communication interface 33, an auxiliary storage device 34, a fan controller 35, a sensor controller 36, and an IPMI management board 37.

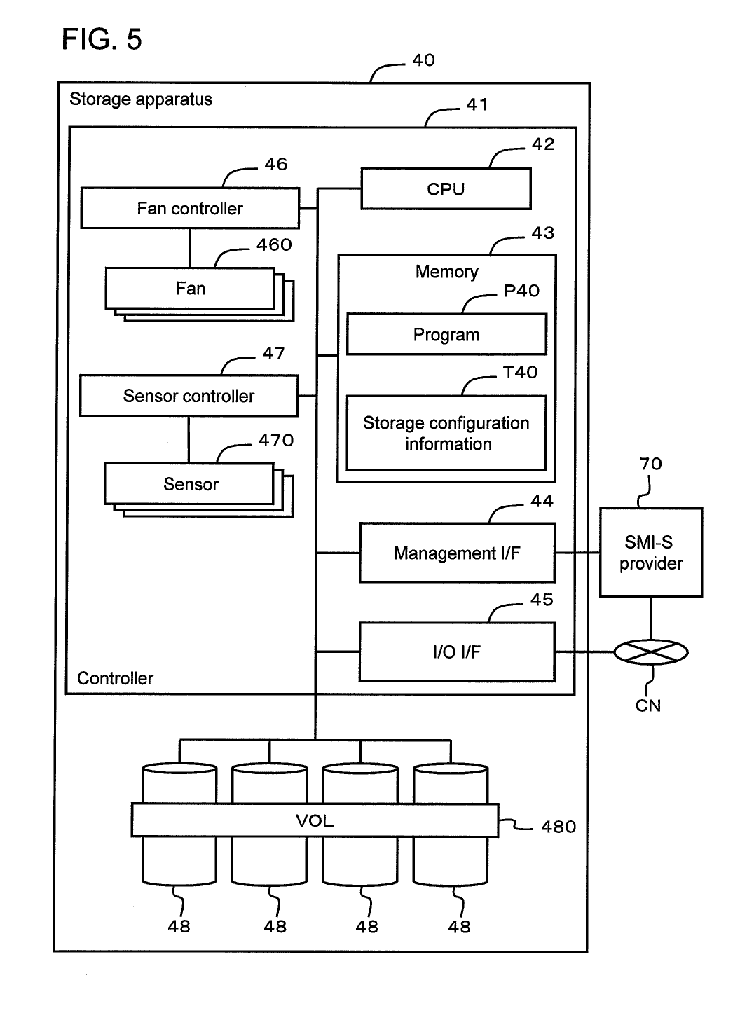

The CPU 31 executes a computer program stored in either the memory 32 or the auxiliary storage device 34. The CPU 31 can access a logical volume 480 (refer to FIG. 5) of the storage apparatus 40 and read/write data by way of the communication interface CN. The CPU 31 is an example of a component that makes up the server computer 30.

The fan controller 35 controls at least one fan 350. The fan 350 is another example of a component that makes up the server computer 30. In a case where cooling changes from air cooling to water cooling, for example, a cooling water pump becomes an example of a component. The cooling water pump is controlled by a pump controller.

The sensor controller 36 controls at least one sensor 360. The sensor 360 is yet another example of a component that makes up the server computer 30. The sensor 360, for example, comprises either a temperature sensor for measuring the temperature inside the enclosure of the server computer 30, or a temperature sensor for measuring the temperature of the CPU 31. The sensor 360 is not limited to a temperature sensor, and, for example, may be another sensor, such as an electric current sensor or a voltage sensor.

The IPMI management board 37 is a substrate for IPMI-based management. The IPMI management board 37, for example, comprises a communication interface 370, a microprocessor 371, and a memory 372. The memory 372 stores a management program P30. The IPMI management board 37 sends server computer 30 management information (apparatus configuration, performance, status, and so forth) to the management computer 10 in accordance with IPMI.

FIG. 5 shows the hardware configuration of the storage apparatus 40, which is one of the management-target apparatuses. The storage apparatus 40 comprises a controller 41 and a storage device 48. The controller 41, for example, comprises a CPU 42, a memory 43, a management communication interface 44, an I/O (Input/Output) communication interface 45, a fan controller 46, and a sensor controller 47.

The CPU 42 executes a computer program P40 stored in the memory 43. The CPU 42 is an example of a component that makes up the storage apparatus 40. The memory 43 also stores information T40 showing a storage configuration. Storage configuration information T40 is information showing which logical volume 480 has been created in accordance with which storage device 48.

The management communication interface 44 is coupled to the communication network CN by way of a SMI-S (Storage Management Initiative-Specification) provider 70. The SMI-S provider 70 may be provided inside the storage apparatus 40, but is not needed in a case where the management communication interface 44 supports SMI-S-based communications. The I/O communication interface 45 is for data communications with the server computer 30 by way of the communication network CN. The communication network CN to which the management communication interface 44 and the I/O communication interface 45 are coupled may differ.

The fan controller 46 controls a fan 460, which is another example of a component that makes up the storage apparatus 40. The sensor controller 47 controls a sensor 470, such as a temperature sensor or a voltage sensor. The sensor 470 is yet another example of a component that makes up the storage apparatus 40.

The storage device 48, for example, is configured as a nonvolatile read/write-enabled storage device such as a hard disk drive or a flash memory device. Physical storage areas of multiple storage devices 48 are virtualized as a single physical storage area, and a logical volume 480, which is a logical storage device, is formed using this virtualized physical storage area.

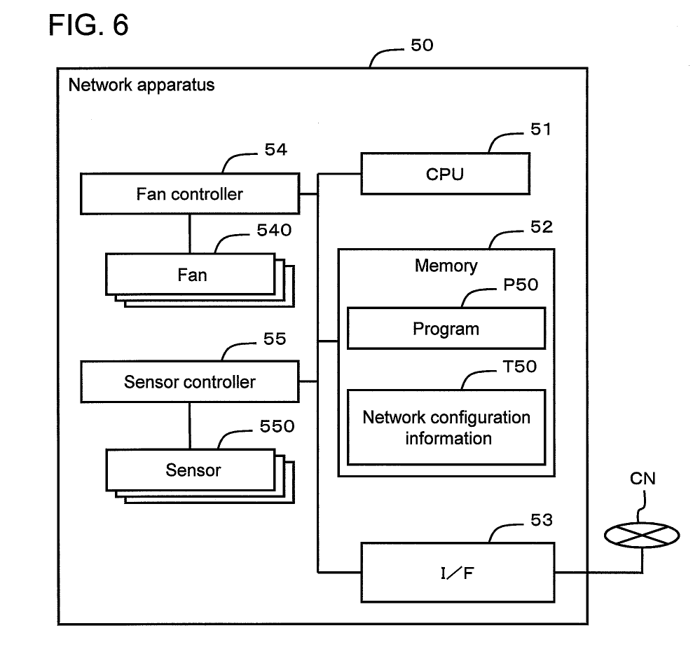

FIG. 6 shows the hardware configuration of the network apparatus 50, which is one of the management-target apparatuses. The network apparatus 50, for example, is configured as an apparatus such as a switching apparatus, a hub, or a router. The network apparatus 50, for example, comprises a CPU 51, a memory 52, a communication interface 53, a fan controller 54, and a sensor controller 55.

The memory 52 stores a computer program P50, which is executed by the CPU 51, and network configuration information T50. The network configuration information T50 manages the coupling relationship with a communication port. The CPU 51 is an example of a component that makes up the network apparatus 50.

The fan controller 54 controls a fan 540, which is another example of a component that makes up the network apparatus 50. The sensor controller 55 controls a sensor 550, which is yet another example of a component that makes up the network apparatus 50.

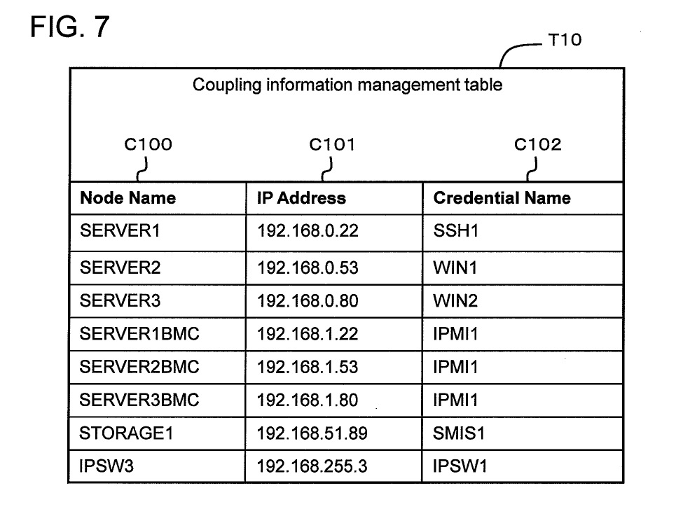

FIG. 7 shows an example of the configuration of the coupling information management table T10. The coupling information management table T10, for example, correspondingly manages a node name C100, an IP address C101, and a credential name C102.

In FIG. 7, the node names include “SERVER1”, “SERVER2”, “SERVER3”, “SERVER1BMC”, “SERVER2BMC”, “SERVER3BMC”, “STORAGE1”, and “IPSW3”.

Of these, the respective physical enclosures of “SERVER1” and “SERVER1BMC”, “SERVER2” and “SERVER2BMC”, and “SERVER3” and “SERVER3BMC have the same coupling information.

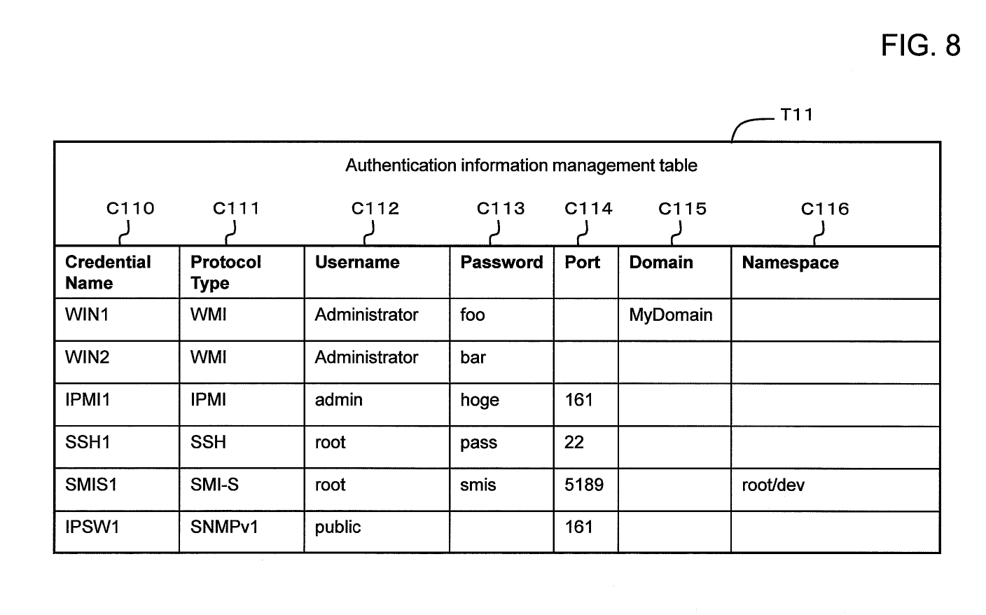

FIG. 8 shows an example of the configuration of the authentication information management table T11. The authentication information management table T11, for example, correspondingly manages a credential name C110, a protocol type C111, a username C112, a password C113, a port number C114, a domain name C115, and a namespace C116.

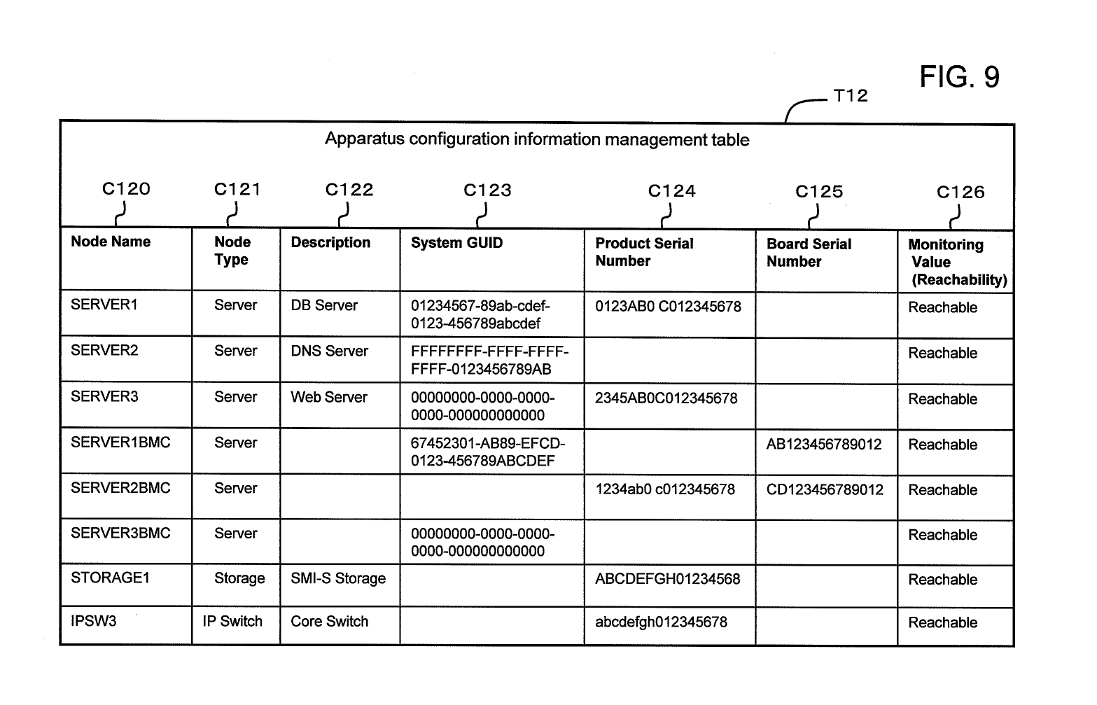

FIG. 9 shows an example of the configuration of the apparatus configuration information management table T12. The apparatus configuration information management table T12, for example, correspondingly manages a node name C120, a node type C121, a description C122, a system GUID C123, a product serial number C124, a board serial number C125, and a monitoring value C126.

A node name, which is the same as the node name listed in node name C100 of the coupling information management table T10, is stored in the node name C120. The type of node (the apparatuses 30 through 60 are called nodes) is stored in the node type C121. A simple description of the node is stored in the description C122. A system GUID value for uniquely identifying each node is stored in the system GUID C123. A serial number configured at node manufacturing time is stored in the product serial number C124. The serial number of the main substrate comprising a node is stored in the board serial number C125. Information showing whether or not a monitoring value is able to be acquired from a node is stored in the monitoring value C126.

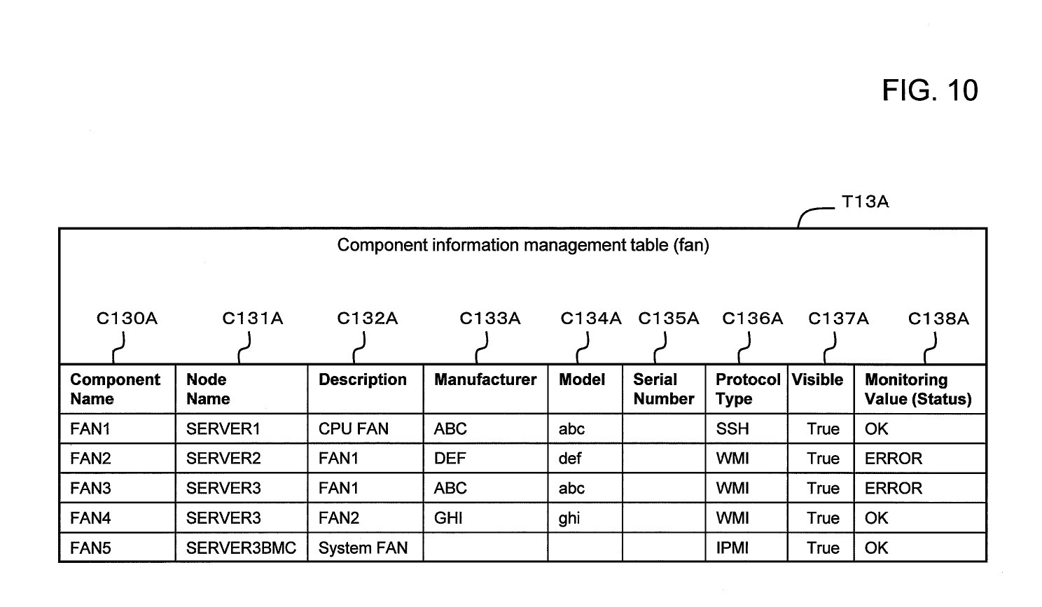

Examples of the configurations of component information management tables T13A through T13C for managing component information will be explained by referring to FIGS. 10 through 12. Since the items of information capable of being managed will differ for each type of component, in this example, a component information management table is prepared for each type of component.

FIG. 10 shows an example of the configuration of the component information management table T13A, which manages information with respect to the fans 350, 460 and 540 that serve as components.

The component information management table T13A, for example, correspondingly manages a component name C130A, a node name C131A, a description C132A, a manufacturer name C133A, a model name C134A, a serial number C135A, a protocol type C136A, a visible flag C137A, and a monitoring value C138A.

A name for identifying a fan inside the information processing system is stored in the component name C130A. The name of the node to which the fan belongs is stored in the node name C131A. A simple description of the fan is stored in the description C132A. The name of the manufacturer of the fan is stored in the manufacturer name C133A. The model name of the fan is stored in the model name C134A. The type of management protocol used for acquiring fan information is stored in the protocol type C136A. Furthermore, the serial number column C135A is empty in FIG. 10, but in a case where a serial number has been acquired, the value thereof is stored in the column C135A.

A value showing whether or not fan information is displayed on a screen is stored in the visible flag C137A. “True” is configured in the visible flag of fan information displayed on a screen G12, which will be described further below. “False” is configured in the visible flag of fan information that is not displayed on the screen G12.

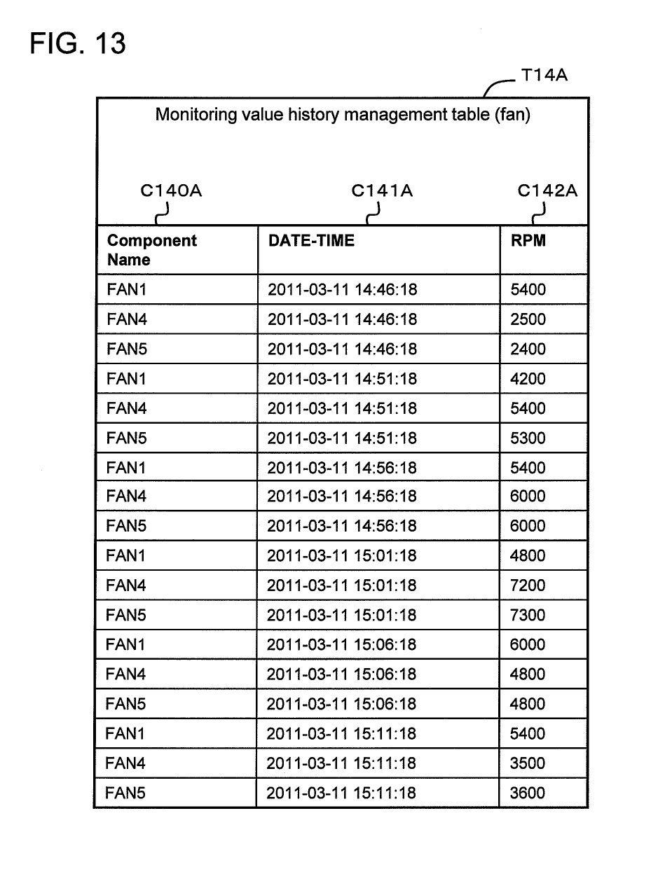

A monitoring value with respect to a fan is displayed in the monitoring value C138A. The monitoring value, for example, may be a value showing a performance, or a value showing a status. In FIGS. 10 through 12, a status value is given as the monitoring value. In a case where the status in normal, “OK” is configured, and in a case where the status is abnormal, “ERROR” is configured. As a performance value, for example, there is fan revolutions per minute as will be described further below using FIGS. 13 through 15.

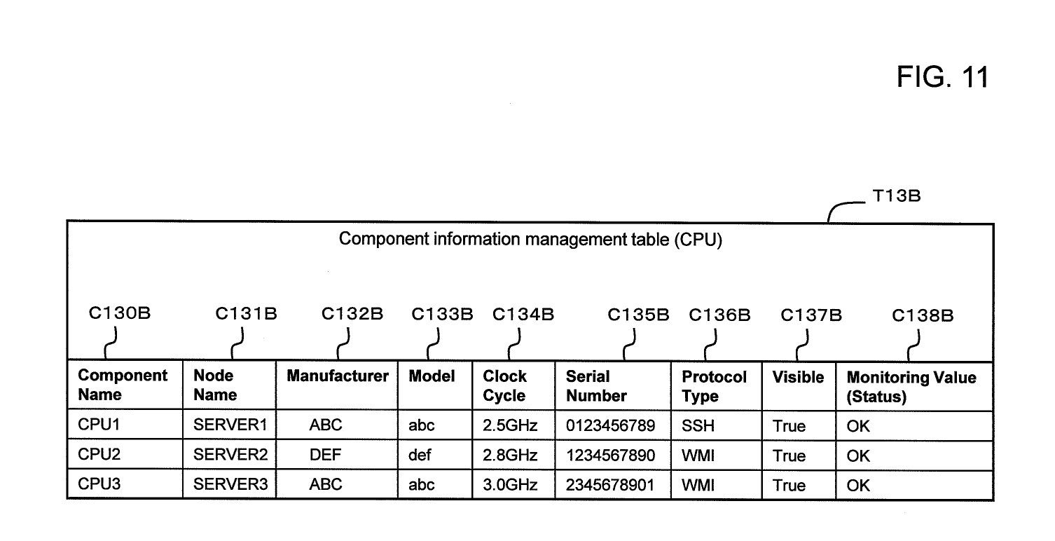

FIG. 11 shows an example of the configuration of the component information management table T13B, which manages information with respect to CPUs 31, 42, and 51 that serve as components.

The component information management table T13B, for example, correspondingly manages a component name C130B, a node name C131B, a manufacturer name C132B, a model name C133B, a clock cycle C134B, a serial number C135B, a protocol type C136B, a visible flag C137B, and a monitoring value C138B.

Explanations will be omitted for columns C130B through C133B and C135B through C138B, which are the same as those described using FIG. 10. A value of the CPU clock frequency is stored in the clock cycle C134B.

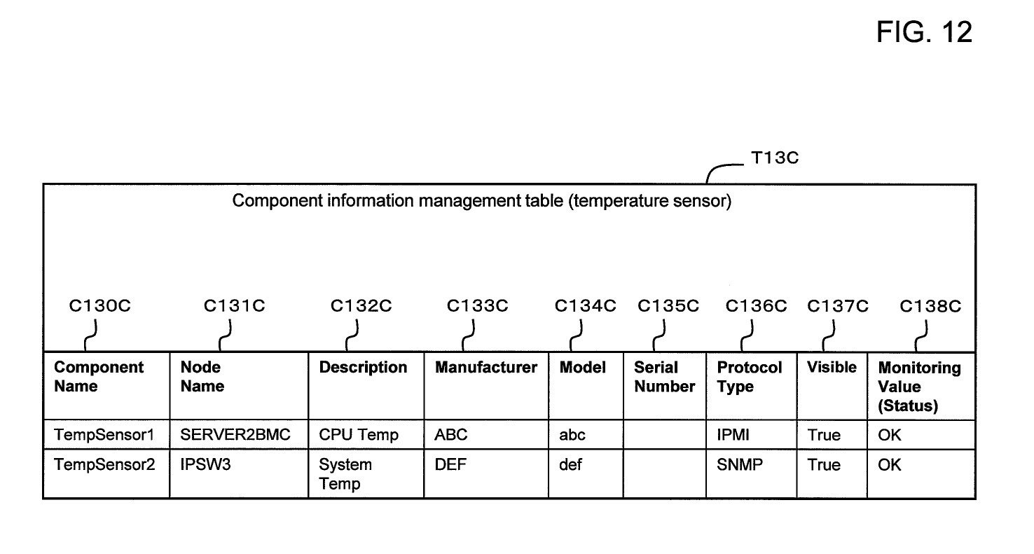

FIG. 12 shows an example of the configuration of the component information management table T13C, which manages information with respect to sensors 360, 470, and 550 that serve as components. Here, an explanation is provided by using a temperature sensor as an example.

The component information management table T13C, for example, correspondingly manages a component name C130C, a node name C131C, a description C132C, a manufacturer name C133C, a model name C134C, a serial number C135C, a protocol type C136C, a visible flag C137C, and a monitoring value C138C.

Tables T14A through T14C for managing the history of monitoring values acquired from components will be explained by referring to FIGS. 13 through 15. Since the type of monitoring value of a management target differs for each type of component, a monitoring value history is managed for each type of component.

FIG. 13 is an example of the configuration of the monitoring value history management table T14A for managing monitoring values (performance values) acquired from the fans 350, 460, and 540 that serve as components. The monitoring value history management table T14A, for example, correspondingly manages a component name C140A, a date-time C141A, and a fan revolution per minute (RPM) C142A. The date-time C141A is information showing the date and time at which a monitoring value was acquired.

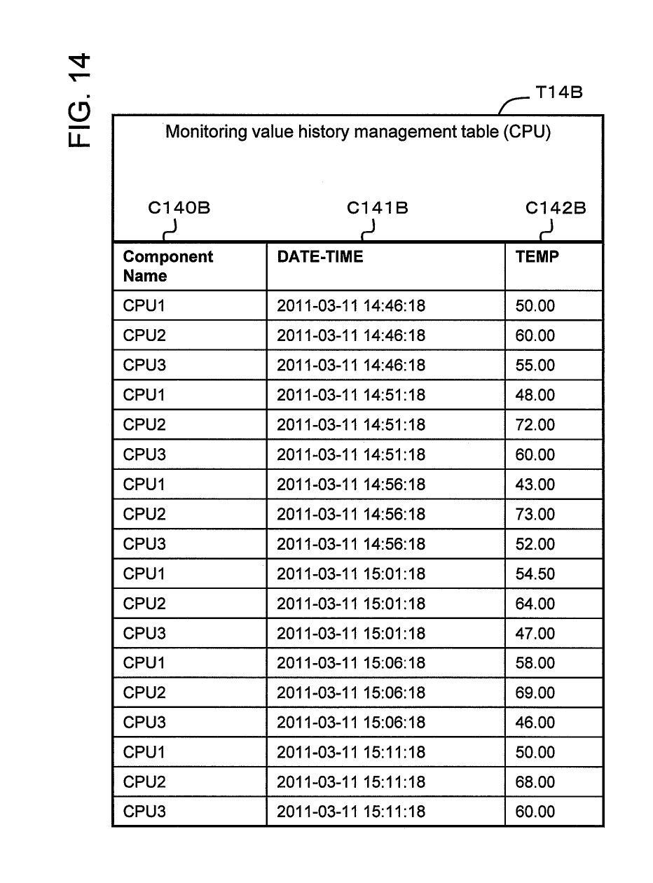

FIG. 14 shows an example of the configuration of the monitoring value history management table T14B for managing monitoring values acquired from the CPUs 31, 42, and 51 that serve as components. The monitoring value history management table T14B, for example, correspondingly manages a component name C140B, a date-time C141B, and a temperature C142B.

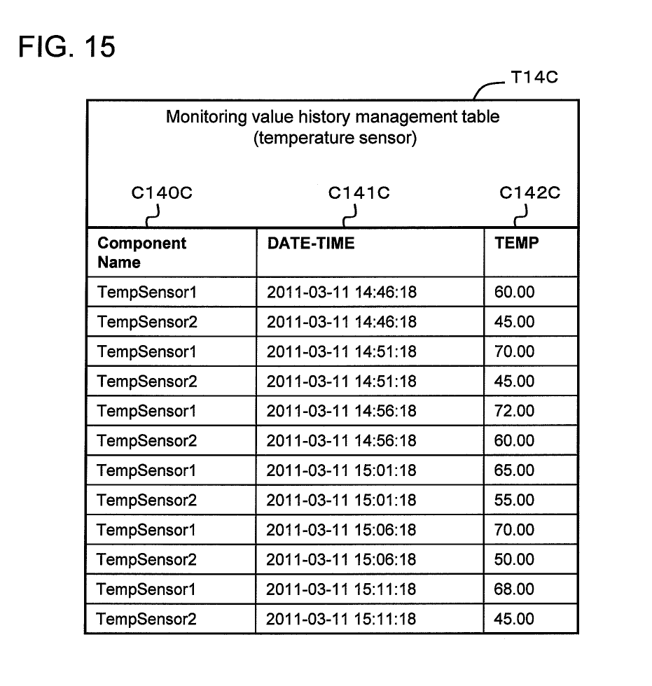

FIG. 15 shows an example of the configuration of the monitoring value history management table T14C for managing monitoring values acquired from the sensors 360, 470, and 550 that serve as components. The monitoring value history management table T14C, for example, correspondingly manages a component name C140C, a date-time C141C, and a temperature C142C.

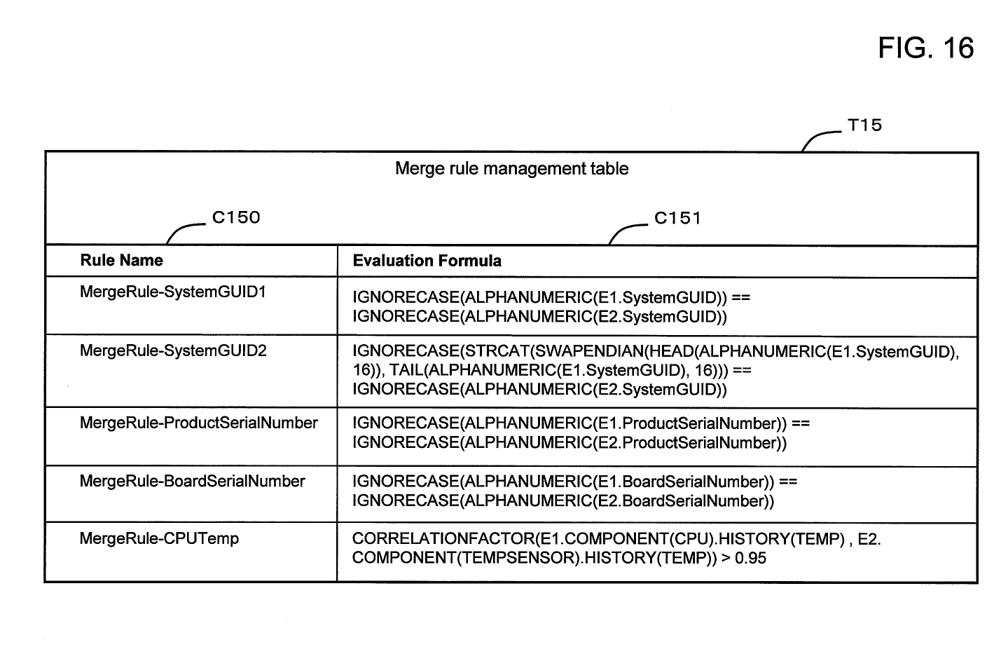

FIG. 16 shows an example of the configuration of a table T15 for managing the merge rule. The merge rule management table T15, for example, manages a merge rule name C150 and an evaluation formula C151. The merge rule, for example, includes a first comparison of the system GUID, a second comparison of the system GUID, a comparison of the product serial number, a comparison of the board serial number, and a comparison of the CPU temperature history.

In the system GUID first comparison, multiple system. GUIDs are simply compared and evaluated as to whether the two match. In the system GUID second comparison, two system GUIDs that apparently differ are compared after carrying out a conversion operation, and an evaluation is performed as to whether the two match.

Despite the fact that the system GUIDs are substantially the same system GUID, there are cases where the system GUID acquired using one management protocol and the GUID acquired using another management protocol appear to be different. Therefore, the “system GUID second comparison” has been prepared.

In the product serial number comparison, two product serial numbers are compared and evaluated as to whether the two match. In the board serial number comparison, two board serial numbers are compared and evaluated as to whether the two match. Furthermore, for convenience of explanation, this example describes cases in which two pieces of information (system GUIDs, product serial numbers, board serial numbers) are compared, but the amount of information is not limited to two pieces, and the configuration may be such that three or more pieces of information are compared.

The system GUID, product serial number, and board serial number are information unique to the apparatus (node). The system GUID first comparison, the system GUID second comparison, the comparison of the product serial number, and the comparison of the board serial number correspond to a “first decision rule”.

Alternatively, the CPU temperature is monitoring information that changes in accordance with the passage of time. The CPU temperature history comparison corresponds to a “second decision rule”.

Examples of embedded functions that are able to be used in the merge rule, or the essential requirement rule, or the aggregation rule here will be explained below.

(1) IGNORECASE (str)

This is a function for returning a character string in which the distinction between uppercase and lowercase letters of the alphabet has been removed from the character string str. For example, this function returns a character string in which all the letters of the alphabet (A to Z and a to z) in the character string str have been converted to either the uppercase or the lowercase.

Ex.) IGNORECASE (“ABC+abc−123.”)→“ABC+ABC−123”
(2) ALPHANUMERIC (str)

This is a function for returning a character string in which characters other than the letters of the alphabet (A to Z and a to z) and numerals (0 to 9) have been removed from the character string str.

Ex.) ALPHANUMERIC (“ABC+abc−123.”)→“ABCabc123”
(3) STRCAT (str1, str2)

This is a function for returning a character string that links character string str1 with character string str2.

### Ex.) STRCAT (“ABC”, “123”)→“ABC123”

(4) SWAPENDIAN (str)

This is a function for interpreting the character string str as a hexadecimal value string representation, and returning a character string, which partitions the character string str at 8 digits from the start, at 4 digits thereafter, and again at 4 digits after that, converts these respective endians, and links together the results of these conversions.

### Ex.) SWAPENDIAN (“0123456789ABCDEF”)→“67452301AB89EFCD”

(5) HEAD (str, count)

This is a function for returning a character string str from the start of the character string str up to the count^{th} character.

### Ex.) HEAD (“ABC123”, 3)→“ABC”

(6) TAIL (str, count)

This is a function for returning a character string str from the count^{th} character from the tail end of the character string str to the tail end.

### Ex.) TAIL (“ABC123”, 3)→“123”

### (7) CORRELATIONFACTOR (set 1, set 2)

This is a function for returning a correlation between an aggregation set 1 and an aggregation set 2. In a case where acquisition times for the information of aggregation set 1 and set 2 differ, a same time value is computed using interpolation. As algorithms for computing the correlation, the Pearson product-moment correlation coefficient, the Spearman rank correlation coefficient, and Kendall's rank correlation coefficients are known. Also, as interpolation algorithms, Newton's interpolation, the Lagrange interpolation, and the splice interpolation are known.

(8) node.COMPONENT (component)

This is a function for returning a component, which belongs to the apparatus configuration information node, and has the name component.

(9) component.HISTORY (value)

This is a function for returning a history aggregation of component monitoring values.

(10) REGEX (equation)

This is a function for returning a regular expression string that is represented using an equation.

Ex.) REGEX (“̂ABC*$”)→“AB”|“ABC”|“ABCC”|“ABCCC”|“ABCCCC”| . . .
Furthermore, in a regular expression, the ̂, $, and * are meta characters respectively signifying the start of a character string, the end of a character string, and that the previous character is repeated 0 times or more.

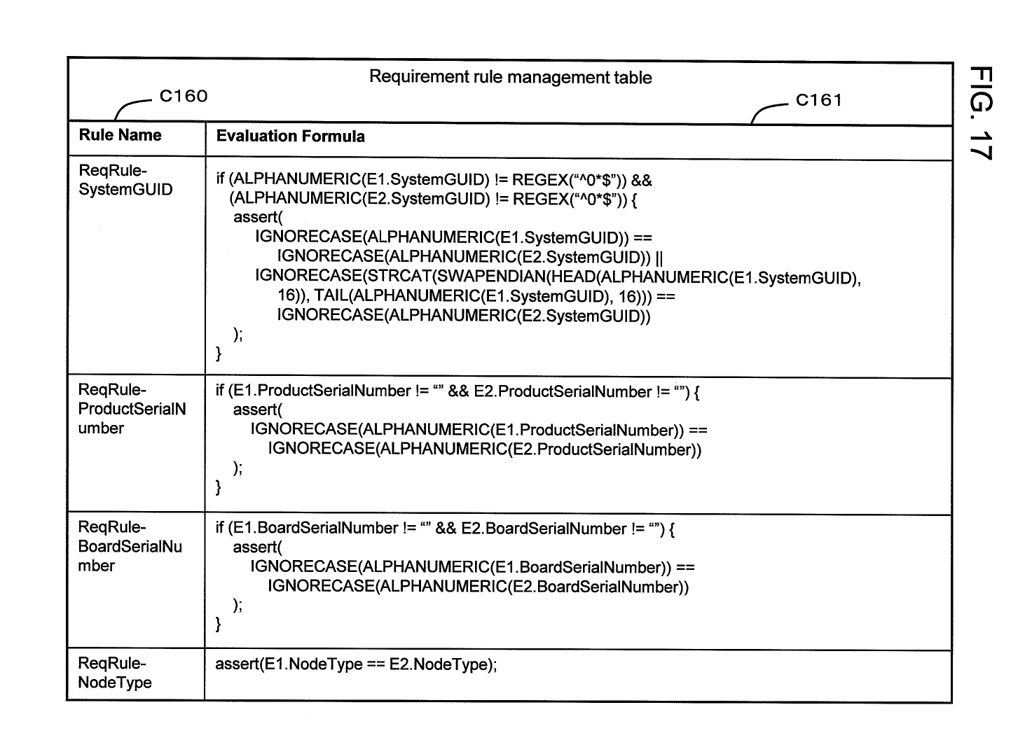

An example of the configuration of a table T16 for managing the essential requirement rule will be explained by referring to FIG. 17. The essential requirement rule management table T16, for example, correspondingly manages an essential requirement rule name C160 and an evaluation formula C161.

As the essential requirement rule, for example, there is a system GUID decision, a product serial number decision, aboard serial number decision, and a node type decision.

In the system GUID decision, as a result of comparing valid system GUIDs, a decision is made as to whether the two match. A valid system GUID is a system GUID other than an invalid system GUID, which comprises only 0s as in “00000 . . . ”. As shown in the system GUID for the “SERVER3” and the system GUID for the “SERVER3BMC” of FIG. 9, a node may return an invalid value in some cases. Consequently, in this example, a check is made as to whether the comparison results for valid system GUIDs are a match.

In the product serial number decision, a decision is made as to whether two product serial numbers match. In the board serial number decision, a decision is made as to whether two board serial numbers match. In the node type decision, a decision is made as to whether two node types match.

The above-mentioned four requirement rules are given as examples, but there may be three or less requirement rules, or there may be five or more requirement rules.

FIG. 18 shows an example of the configuration of a table T17 for managing the aggregation rule. The aggregation rule management table T17, for example, correspondingly manages an aggregation rule name C170, a target component type C171, an evaluation formula C172, and a protocol priority C173. An explanation of FIG. 18 will be given using a fan as an example.

The aggregation rule is a condition for detecting component information originating from the same component, and corresponds to a “component merge rule”. In a first rule, which corresponds to a “component first decision rule”, the serial numbers of two fans are compared, and an evaluation is made as to whether the two match. In a second rule, which corresponds to a “component second decision rule”, the RPM histories of two fans are compared, and an evaluation is made as to whether the RPM change patterns match a value equal to or greater than a prescribed percentage.

In the first rule, serial numbers, which are unique information, are compared, and in the second rule, RPM histories, which are dynamic monitoring information, are compared.

In the protocol priority C173, the priority of each management protocol is configured for each rule. In this example, for example, the configuration is such that the priority increases from WMI, SSH, SNMP to IPMI, in that order (WMI>SSH>SNMP>IPMI).

In this example, only component information acquired using a high-priority management protocol is displayed on a screen from among duplicate multiple pieces of component information, and component information other than this is not displayed on a screen.

The operation of the management computer 10 will be explained by referring to FIGS. 19 through 32. The processes described hereinbelow are realized by the CPU 11 executing respective computer programs P10 through P19 stored in the memory 12. Therefore, any of the management computer, the microprocessor, or the computer program may be responsible for performing the processing. The following explanation will treat the management computer 10 as the one primarily responsible for performing operations.

FIG. 19 is a flowchart showing a process for acquiring management information. This process may be called a discovery process. The management computer 10 executes steps S11 through S14 for all IP addresses listed in the coupling information management table T10 (S10). The IP address that constitutes the target of the processing is called the target IP address.

First, the management computer 10 acquires authentication information (a username C112 and a password C113) corresponding to the target IP address from the authentication information management table T11 based on the credential name C110 (S11). The management computer 10 accesses and logs into the apparatus (target apparatus) comprising the target IP address, and acquires the configuration information of the target apparatus (S12).

Next, the management computer 10 makes a decision as to whether the acquisition of configuration information from the target apparatus was a success (S13). In a case where the configuration information could be acquired (S13: YES), the management computer 10 adds an entry listing the target apparatus node name to the component information management table T13 (S14), and proceeds to step S15. In a case where the acquisition of the configuration information has failed (S13: NO), the management computer 10 skips step S14 and moves to step S15.

After attempting to read the configuration information for all the apparatuses (nodes) registered in the coupling information management table T10, the management computer 10 executes a process for acquiring a monitoring value (S15).

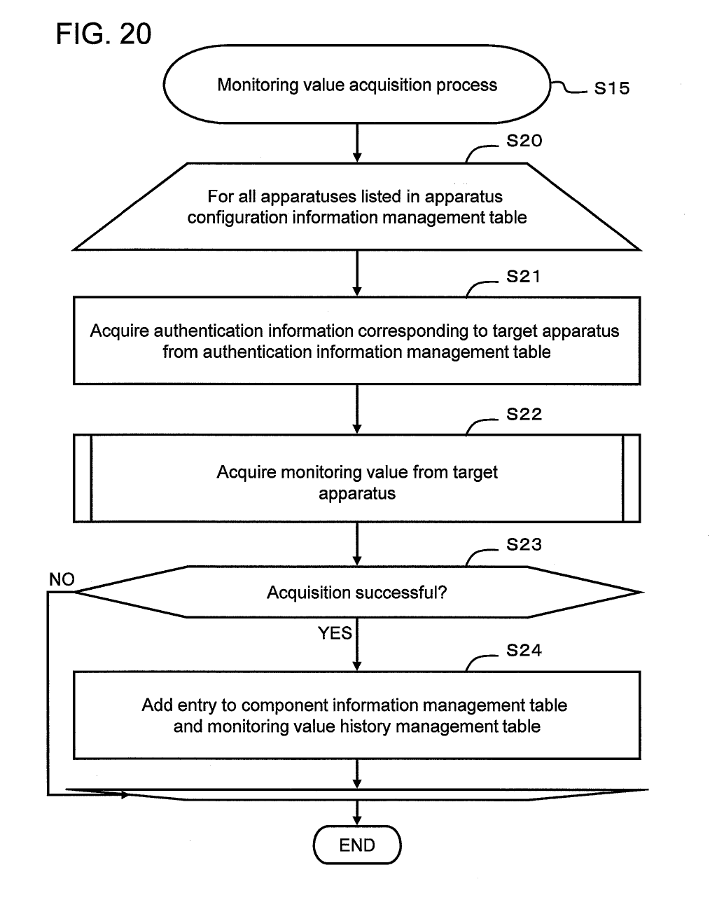

FIG. 20 is a flowchart showing a process for acquiring a monitoring value from an apparatus. The management computer 10 executes steps S21 through S24 for all the apparatuses listed in the apparatus configuration information management table T12 (S20).

The management computer 10 acquires authentication information corresponding to a target apparatus from the authentication information management table T11 (S21), uses this authentication information to log into the target apparatus, and acquires a monitoring value from the target apparatus (S22).

The management computer 10 decides whether the acquisition of the monitoring value was successful (S23). In a case where the monitoring value acquisition was successful (S23: YES), the management computer 10 adds an entry to each of the component information management table T13 and the monitoring value history management table T14, and stores the monitoring value (S24).

In a case where the monitoring value acquisition has failed (S23: NO), the management computer 10 skips step S24 and moves to the next target apparatus.

As described using FIGS. 19 and 20, the management computer 10 first acquires configuration information from the target apparatus (FIG. 19), and then acquires a monitoring value from the target apparatus (FIG. 20).

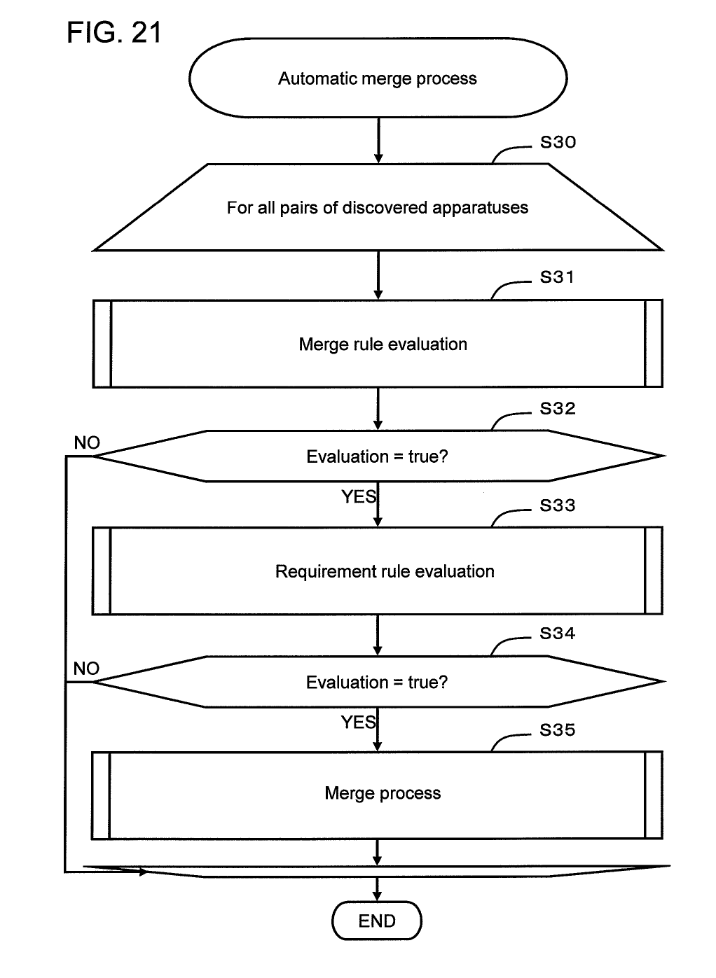

FIG. 21 is a flowchart showing a process for automatically discovering duplicate apparatus configuration information and merging this information as a single piece of apparatus configuration information.

The management computer 10 executes steps S31 through S35 for all the pairs of all the discovered apparatuses listed in the apparatus configuration information management table T12 (S30).

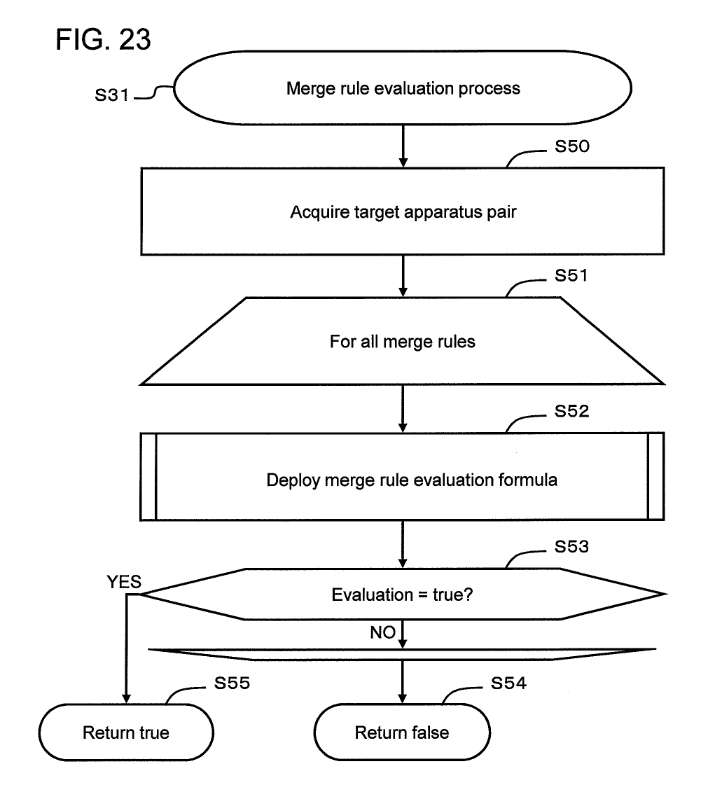

The management computer 10 first applies the merge rule with respect to two target apparatuses that have been selected, and evaluates the result thereof (S31). The process for evaluating the merge rule will be described in detail using FIG. 23. Precisely speaking, the target of the processing here is a combination of pieces of apparatus configuration information, but to simplify the explanation, the processing target may be called the target apparatus combination.

The management computer 10 decides whether the merge rule evaluation result is true (S32). In a case where the evaluation result is false (S32: NO), the management computer 10 moves to another target apparatus combination.

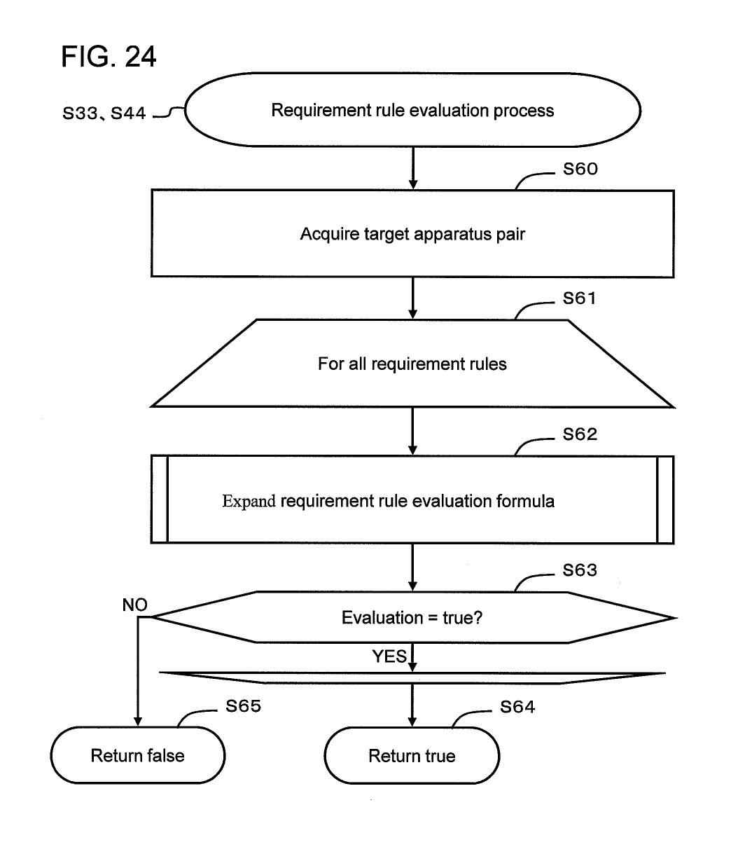

In a case where the evaluation result is true (S32: YES), the management computer 10 applies the essential requirement rule to the target apparatus combination and evaluates the result (S33). The process for evaluating the essential requirement rule will be described in detail using FIG. 24.

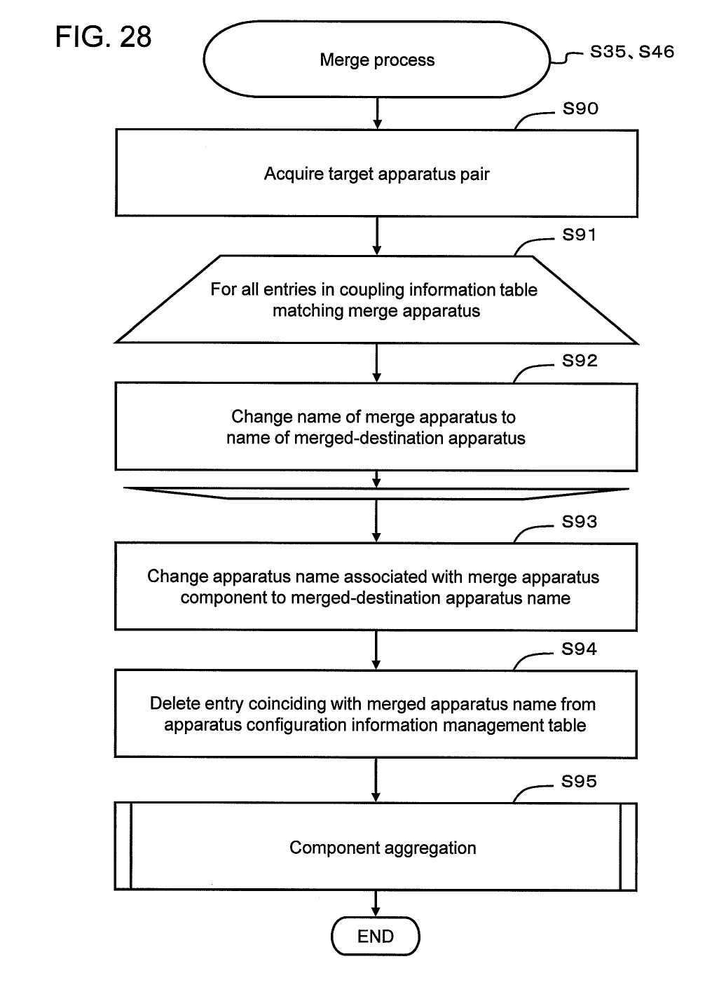

The management computer 10 decides whether the essential requirement rule evaluation result is true (S34). In a case where the evaluation result is false (S34: NO), the management computer 10 moves to another target apparatus combination. In a case where the evaluation result is true (S34: YES), the management computer 10 executes the merge rule for the target apparatus combination (S35). The merge rule will be described in detail using FIG. 28.

In this example, an automatic mode for automatically detecting and merging duplicate pieces of apparatus configuration information like this has been prepared. Therefore, the system administrator or other such user can automatically organize numerous pieces of apparatus configuration information acquired from the information processing system by selecting and executing the automatic mode. In addition, in this example, a manual mode is also provided. The manual mode is the merge support mode for merging a user-selected target apparatus combination.

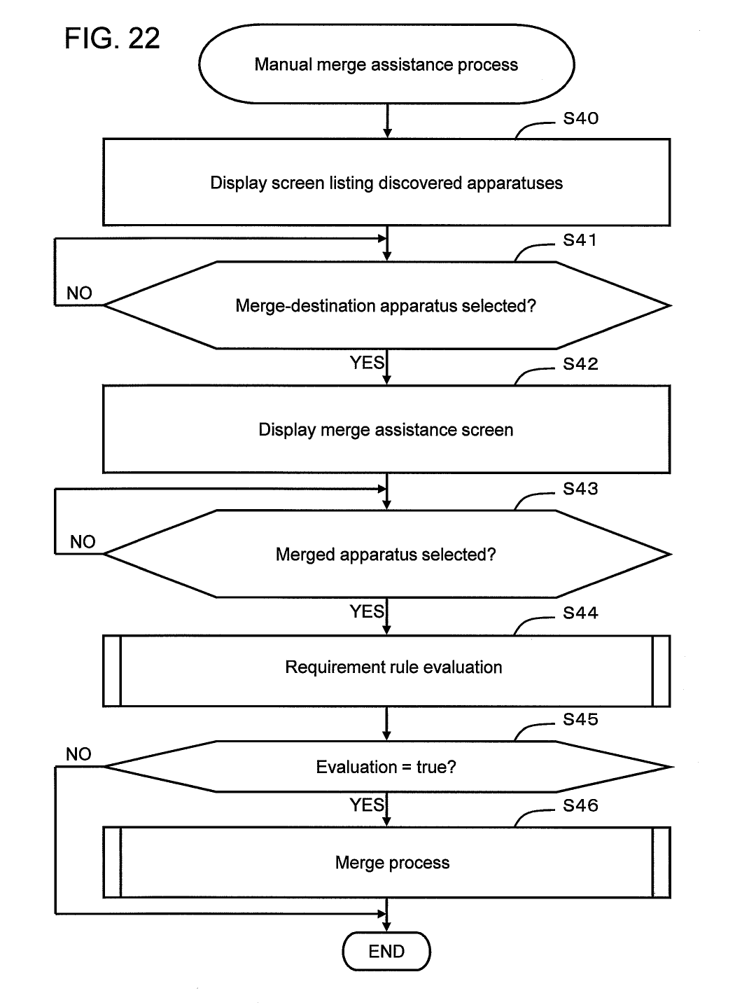

FIG. 22 is a flowchart showing a process for supporting the merge of a target apparatus combination selected by the user.

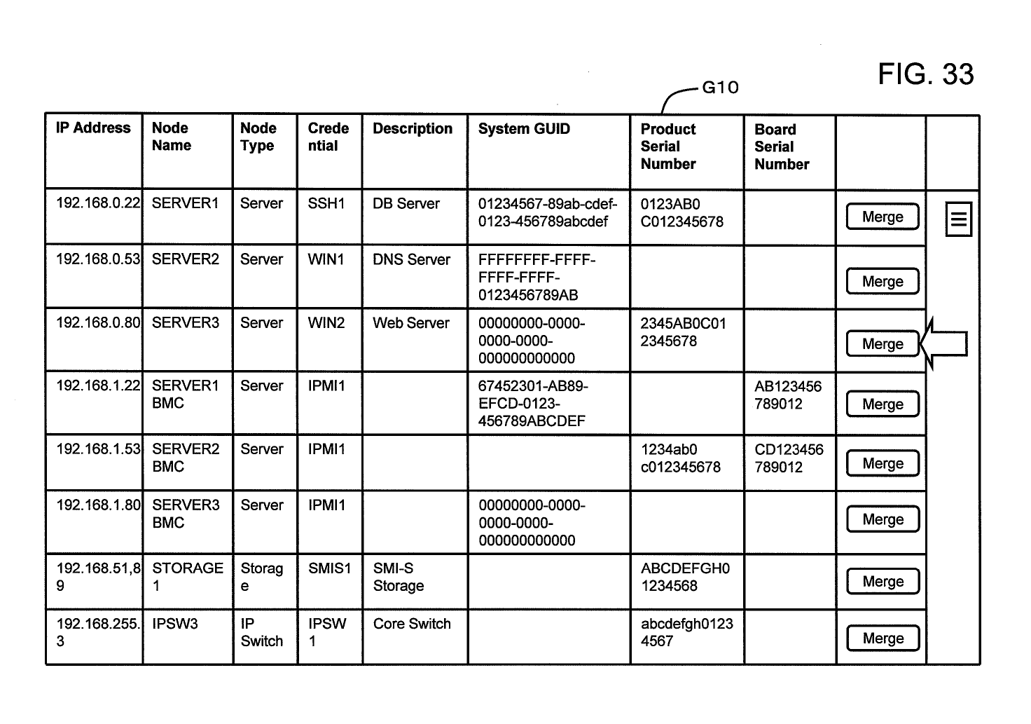

The management computer 10 creates a discovered apparatus listing screen G10, which is shown in FIG. 33, sends this screen to the client computer 20, and causes the user interface device 24 of the client computer 20 to display this screen (S40).

Refer to FIG. 33. The screen G10 shows a list of apparatuses that have been discovered. In the screen G10, for example, there is displayed an IP address, a node name, a node type, a credential name, a description, a system GUID, a product serial number, and a board serial number for each apparatus that was discovered.

Return to FIG. 22. A button (Merge button) for instructing a merge is displayed in each row of the screen G10 corresponding to an apparatus. The user selects one apparatus from the screen G10 to be the merge destination, and operates the Merge button (S41).

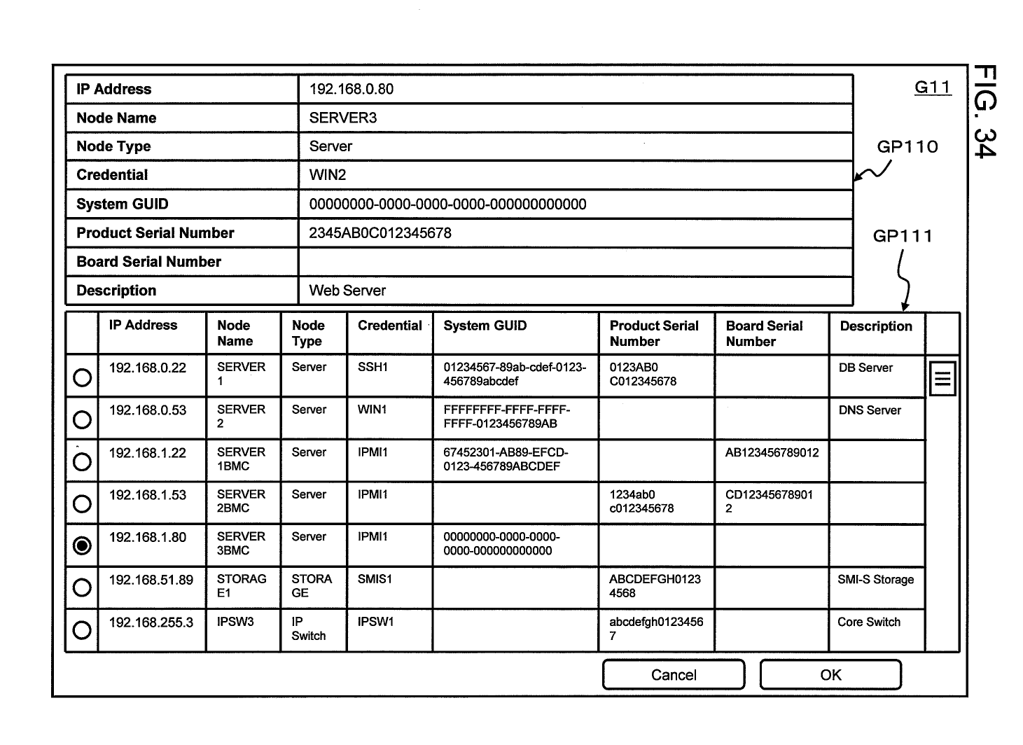

When the merge-destination apparatus is selected (S41: YES), the management computer 10 creates a merge support screen G11, which is shown in FIG. 34, and causes the user interface device 24 of the client computer 20 to display this screen (S42).

Refer to FIG. 34. The screen G11 for supporting a merge instruction by the user comprises two areas. The one is a merge-destination apparatus display area GP110 for displaying information related to the merge-destination apparatus. The other is a candidate display area GP111 for displaying information related to a merged apparatus candidate.

The candidate display area GP111, for example, displays an IP address, a node name, a node type, a credential name, a system GUID, a product serial number, a board serial number, and a description for a merged apparatus candidate. The display items of the display screen GP110 and the display screen GP111 may be the same or may be different.

The user selects at least one merged apparatus from the list of merged apparatus candidates, and operates the OK button.

Return to FIG. 22. The management computer 10 decides whether a merged apparatus has been selected by the user (S43). In a case where a merged apparatus has been selected (S43: YES), the management computer 10 applies the essential requirement rule to the merge-destination apparatus (S41) and the merged apparatus (S43) selected by the user, and evaluates the result (S44). The essential requirement rule evaluation process will be described further below using FIG. 24.

The management computer 10 decides whether the essential requirement rule evaluation result is true (S45). In a case where the evaluation result is true (S45: YES), the management computer 10 executes a merge process for merging the merged apparatus with the merge-destination apparatus (S46). The merge process will be described further below using FIG. 28. In a case where the essential requirement rule evaluation result is not true, that is, in a case where the evaluation result is false (S45: NO), this processing ends.

In this example, in a case where the user manually selects a merge-target apparatus like this, the suitability of this combination is automatically decided (S44), and the merge process is only performed in a case where this combination has been determined to be appropriate.

FIG. 23 is a flowchart showing the process for evaluating the merge rule (S31 of FIG. 21) in detail. First, the management computer 10 acquires an evaluation-target apparatus combination (a pair of the merge-destination apparatus and the merged apparatus) (S50).

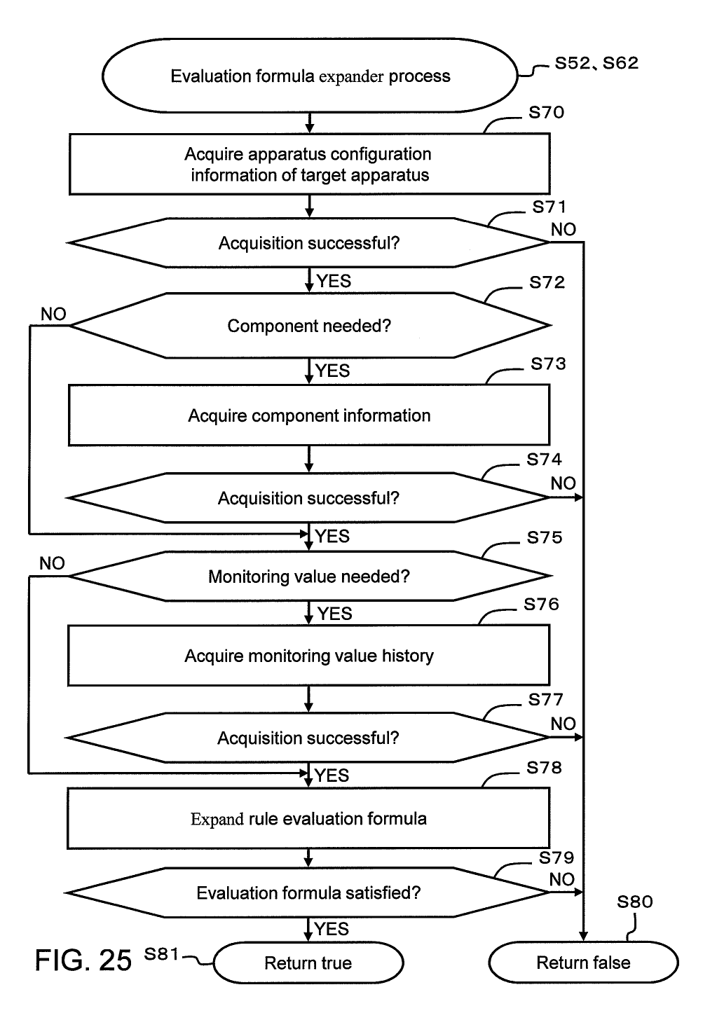

The management computer 10 selects one merge rule in the order in which the merge rules are registered in the merge rule management table T15, applies the selected merge rule to the target apparatus combination, and expands (creates) a formula for evaluating the merge rule application result (S52). The process for expanding the evaluation formula will be described in detail further below using FIG. 25.

The management computer 10 decides whether the result of the evaluation of the merge rule with respect to the target apparatus combination is true (S53). In a case where the target apparatus combination satisfies the merge rule, this result is true. In a case where the merge rule evaluation result is true (S53: YES), the management computer 10 returns true as the evaluation result with respect to the flowchart of FIG. 21 (S55).

Alternatively, in a case where the target apparatus combination does not satisfy the merge rule, this result is false. In a case where the merge rule evaluation result is false (S53: NO), the management computer 10 returns false as the evaluation result with respect to the flowchart of FIG. 21 (S56). Thereafter, the management computer 10 returns to step S51, selects the next merge rule (S52), and applies this merge rule to the target apparatus combination (S53).

In the process for evaluating the merge rule, the merge rules listed in the merge rule management table T15 are applied to target apparatus combinations and evaluated in order, and in a case where the evaluation result is true, the processing ends. In a case where the result of applying “the system GUID first comparison” to the target apparatus combination is true, the management computer 10 ends the processing of FIG. 23 without applying another merge rule to this target apparatus combination.

In the merge rule management table T15, a merge rule based on unique information is listed first, and a merge rule based on a monitoring value is listed last. Therefore, the suitability of a merge with respect to a target apparatus combination can be determined quickly based on relatively high reliability unique information. By contrast, in a case where an evaluation is performed from the monitoring value-based merge rule first, the patterns of the monitoring value histories must be compared, increasing the load of the evaluation process.

FIG. 24 is a flowchart showing a process for evaluating the essential requirement rule. The evaluation of the essential requirement rule is executed in step S33 of FIG. 21 and step S44 of FIG. 22.

The management computer 10 acquires the apparatus pair to be the target of the evaluation (S60). The management computer 10 selects one requirement rule from the essential requirement rules listed in the essential requirement rule management table T16 shown in FIG. 17 (S61), applies this requirement rule to the target apparatus combination, and performs the evaluation (S62). The process (S62) for creating the formula for evaluating the essential requirement rule will be described in detail further below using FIG. 25.

The management computer 10 decides whether the essential requirement rule evaluation result is true (S63). In a case where the evaluation result is true (S63: YES), the management computer 10 returns to step S61 and selects the next requirement rule. The management computer 10 applies this requirement rule to the target apparatus combination and performs an evaluation (S62), and decides whether the evaluation result is true (S63).

The management computer 10 applies all the essential requirement rules to the target apparatus combination and performs evaluations in order like this, and checks whether this target apparatus combination satisfies all of the essential requirement rules. In a case where the target apparatus combination satisfies all of the essential requirement rules (S63: YES), the management computer 10 returns true as the evaluation result with respect to the flowchart shown either FIG. 21 or FIG. 22 (S64).

Alternatively, in a case where the target apparatus combination does not satisfy one of the essential requirement rules (S63: NO), the management computer 10 returns false as the evaluation result with respect to the flowchart of either FIG. 21 or FIG. 22 (S65).

Since the requirement result is a condition that must be satisfied by multiple apparatuses that are to be merged, in this example, this merge is permitted only in a case where the target apparatus combination satisfies all of the essential requirement rules. This prevents the mistaken merger of apparatuses (apparatus configuration information) whose physical enclosures are completely different.

FIG. 25 is a flowchart showing a process for expanding an evaluation formula. This process is executed in step S52 of FIG. 23 and step S62 of FIG. 24.

At the start of this process, the management computer 10 respectively acquires a target apparatus combination and a merge rule, and, in addition, acquires the apparatus configuration information of the target apparatuses from the apparatus configuration information management table T12 (S70). The management computer 10 decides whether the acquisition of the apparatus configuration information of the target apparatuses was successful (S71). In a case where the apparatus configuration information of the target apparatuses could not be acquired (S71: NO), the management computer 10 returns false as the evaluation result with respect to the flowchart of either FIG. 23 or FIG. 24 (S80).

In a case where it was possible to acquire the apparatus configuration information of the target apparatuses (S71: YES), the management computer 10 decides whether the component information of the target apparatuses is needed (S72). In a case where a rule (a merge rule) based on a monitoring value history is evaluated, the component information is needed.

In a case where a decision has been made that the component information is needed for evaluating the rule (S72: YES), the management computer 10 acquires the required component information from the component information management table T13 (S73). The management computer 10 decides whether the component information was able to be acquired (S74).

In a case where the acquisition of a monitoring value history has failed (S74: NO), the management computer 10 returns false as the evaluation result with respect to the flowchart of either FIG. 23 or FIG. 24 (S80). Furthermore, in a case where the component information is not needed (S72: NO), steps S73 and S74 are skipped and the processing moves to S75.

In a case where the acquisition of the component information was successful (S74: YES), the management computer 10 decides whether a monitoring value history is needed (S75). As described hereinabove, in a case where an evaluation is performed using the monitoring value history, a history of monitoring values is needed.

In a case where it has been decided that the monitoring value history is needed (S75: YES), the management computer 10 acquires the required monitoring value history from the monitoring value history management table T14 (S76). The management computer 10 decides whether the monitoring value history was able to be acquired (S77).

In a case where the acquisition of the monitoring value history failed (S77: NO), the management computer 10 returns false as the evaluation result with respect to the flowchart of either FIG. 23 or FIG. 24 (S80). Furthermore, in a case where the monitoring value history is not needed (S75: NO), steps S76 and S77 are skipped, and the processing moves to S78.

In a case were either the monitoring value history was able to be acquired (S77: YES) or the monitoring value history is not needed (S75: NO), the management computer 10 creates a formula for evaluating the rule (S78), and decides whether the evaluation formula has been satisfied (S79).

In a case where the evaluation formula has been satisfied (S79: YES), the management computer 10 returns true as the evaluation result with respect to the flowchart of either FIG. 23 or FIG. 24 (S81). In a case where the evaluation formula has not been satisfied (S79: NO), the management computer 10 returns false as the evaluation result with respect to the flowchart of either FIG. 23 or FIG. 24 (S80).

Thus, in this example, in a case where an evaluation is performed using only the unique information of the apparatuses, the component information and the monitoring value history are not needed, and the processing is performed in the order of Steps S70, S71, S72: N0, S75: N0, S78 and S79.

A specific example will be explained. With regard to an automatic merge process, a process for carrying out the automatic merge process with respect to a combination of the two pieces of apparatus configuration information “SERVER1” and “SERVER1BMC” will be described.

In S31 of the automatic merge process shown in FIG. 21, the combination of apparatus configuration information “SERVER1” and “SERVER1BMC” is inputted in S50 of the merge rule evaluation process of FIG. 23.

In S51, the management computer 10 refers to the merge rule management table T15 shown in FIG. 16, and acquires all the merge rules. In S52, each merge rule is applied to the combination of apparatus configuration information inputted in S50, and an evaluation as to whether or not the merge rule is satisfied is performed.

In S70 of the evaluation formula expansion process shown in FIG. 25, the management computer 10 respectively acquires the information of the apparatus configuration information “SERVER1” and “SERVER1BMC” from the apparatus configuration information management table T12 shown in FIG. 9.

It is supposed here that the merge rule inputted in S70 is the “system GUID second comparison” (MergeRule-SystemGUID2), and that the system GUIDs of “SERVER1” and “SERVER1BMC” were able to be acquired from the apparatus configuration information management table T12.

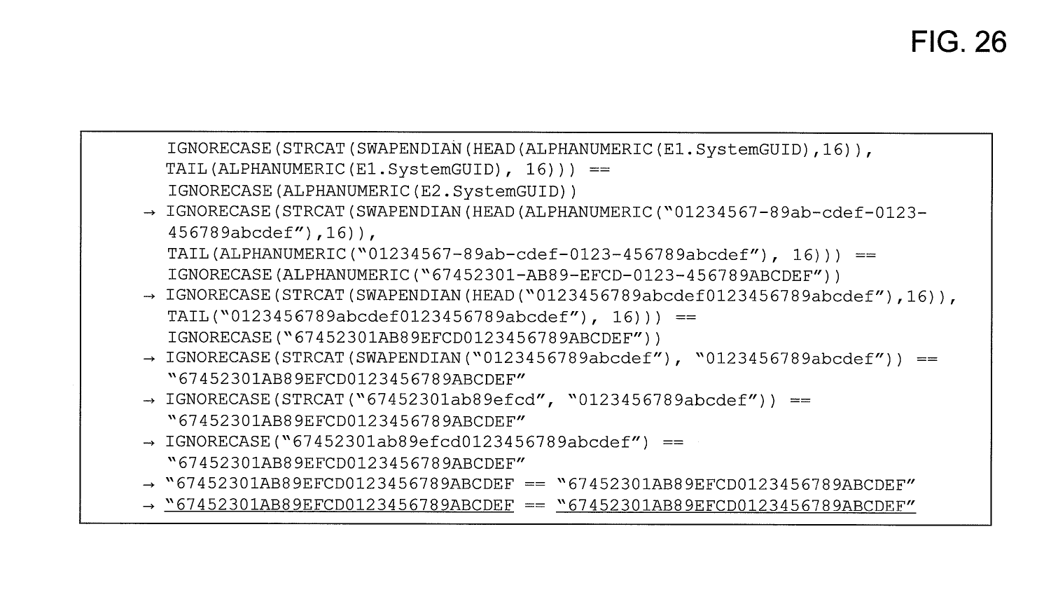

Component information is not needed for evaluating the merge rule (MergeRule-SystemGUID2). Therefore, steps S73 and S74 are skipped. In addition, a monitoring value history is also not needed to evaluate this merge rule. Therefore, steps S76 and S77 are skipped. Then, in S78, the merge rule evaluation formula is created. An example of a specific evaluation formula is shown in FIG. 26.

Since the result of expanding the merge rule (MergeRule-SystemGUID2) is true, true is returned as the evaluation result in S81. Therefore, in S53 shown in FIG. 23, it is decided that the evaluation result is true, and true is returned as the evaluation result with respect to FIG. 21 (S55).

In accordance with this, an essential requirement rule evaluation is performed in S33 of FIG. 21. In S61, the management computer 10 refers to the essential requirement rule management table T16 shown in FIG. 17, and acquires all the essential requirement rules.

In S62, the respective requirement rules acquired in S61 are expanded with respect to the pair of apparatus configuration information acquired in S60.

In the combination of apparatus configuration information of “SERVER1” and “SERVER1BMC”, the evaluation results for all the essential requirement rules are true. Therefore, in S64, true is returned as the evaluation result. In accordance with this, the merge rule is executed in S35 of FIG. 21.

Another example will be cited. In a combination of the apparatus combination information “STORAGE1” and “IPSW3”, the merge rule (MergeRule-ProductSerialNumber) that compares product serial numbers is satisfied. However, in this combination of apparatus configuration information, the evaluation result of the essential requirement rule (ReqRule-NodeType), which requires that the node types match, is false (S34: NO), and as such the merge process is not performed.

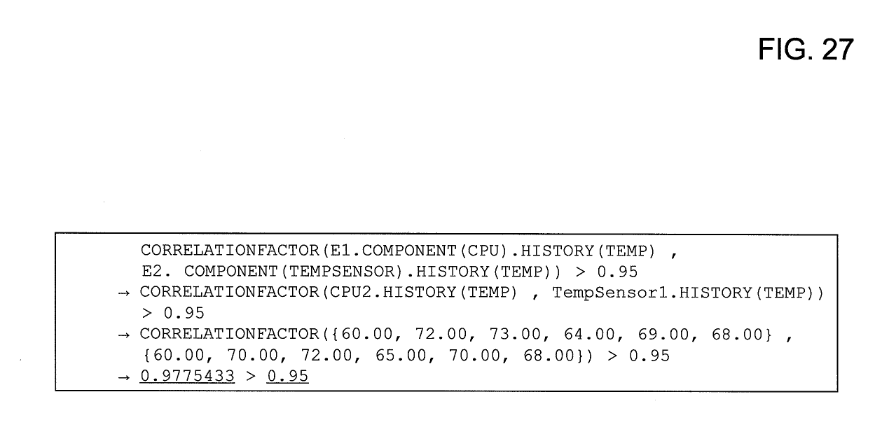

The automatic merge process that uses the monitoring value is the same as the automatic merge process that uses the above-described apparatus configuration information. In a combination of the two pieces of apparatus configuration information “SERVER2” and “SERVER2BMC”, the merge rule (MergeRule-CPUTemp) is satisfied. An example of a specific evaluation formula is shown in FIG. 27. Furthermore, it is supposed that the correlation computation algorithm used in the embedded function CORRELATIONFACTOR shown in FIG. 27 is the Pearson product-moment correlation coefficient.

FIG. 28 is a flowchart showing the merge process. This process is executed in S35 of FIG. 21 and S46 of FIG. 22.

First, the management computer 10 acquires a target apparatus pair (a pair of the apparatus configuration information that is to be the target) (S90). The management computer executes the following step S92 for all entries in the coupling information management table T10 in which the node name matches the node name of the merged apparatus (S91). That is, the management computer 10 changes the node name of the merged apparatus to the node name of the merge-destination apparatus (S91).

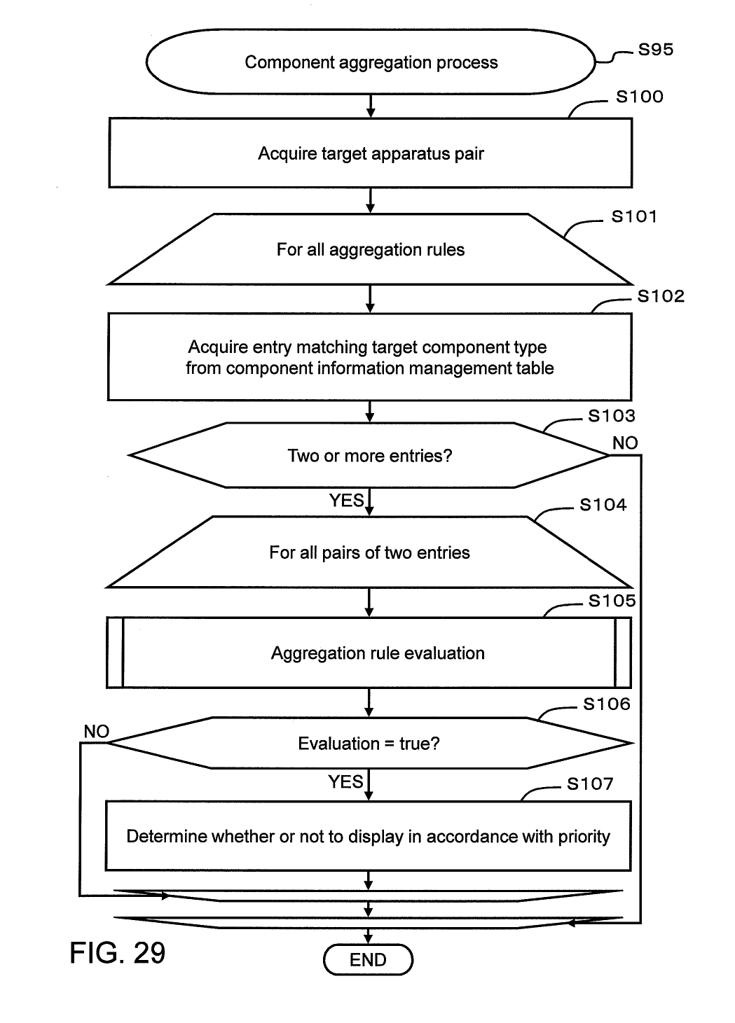

The management computer 10 changes the node name, which matches the node name of the merged apparatus, to the node name of the merge-destination apparatus in the component information management table T13 (S93). The management computer 10 deletes all the entries comprising the node name of the merged apparatus in the apparatus configuration information management table T12 (S94). In addition, the management computer 10 executes a process for aggregating the component information (S95). The process for aggregating the component information will be described in detail further below using FIG. 29.

A specific example of a merge process will be explained. In S91, the management computer 10 refers to the coupling information management table T10 shown in FIG. 7, and acquires the information in all the entries in which “SERVER1BMC”, which is the node name of the merged apparatus, is configured in the node name C100.

In S92, the management computer 10 changes the node name of the entry acquired in S91 to “SERVER1”, which is the node name of the merge-destination apparatus. In S93, the management computer 10 refers to the component information management table T13, and changes the node name of the entry in which the merged apparatus node name “SERVER1BMC” is configured in the node name C131 to “SERVER1”, which is the node name of the merge-destination apparatus. In S94, the management computer 10 deletes the coupling information of the merged apparatus from the coupling information management table T10. This completes the merging of the apparatus configuration information.

FIG. 29 is a flowchart showing the process for aggregating the component information (S95) in detail. The management computer 10 acquires the target apparatus pair (S100), and executes steps S102 through S107 for all aggregation rules listed in the aggregation rule management table T17 shown in FIG. 18 (S101). FIG. 18 only shows aggregation rules for a fan, but in actuality, aggregation rules are prepared for each component type.

The management computer 10 acquires an entry which matches the component type that is to become the target from the component information management table T13 (S102). The management computer 10 decides whether there are two or more entries corresponding to the target component type (S103). In a case where there are not two or more entries corresponding to the target component type (S103: NO), aggregation-target information does not exist, and this processing ends.

In a case where there are two or more entries corresponding to the target component type (S103: YES), the management computer 10 executes steps S105 through S107 for all pairs of two entries created from among these two or more entries (S104).

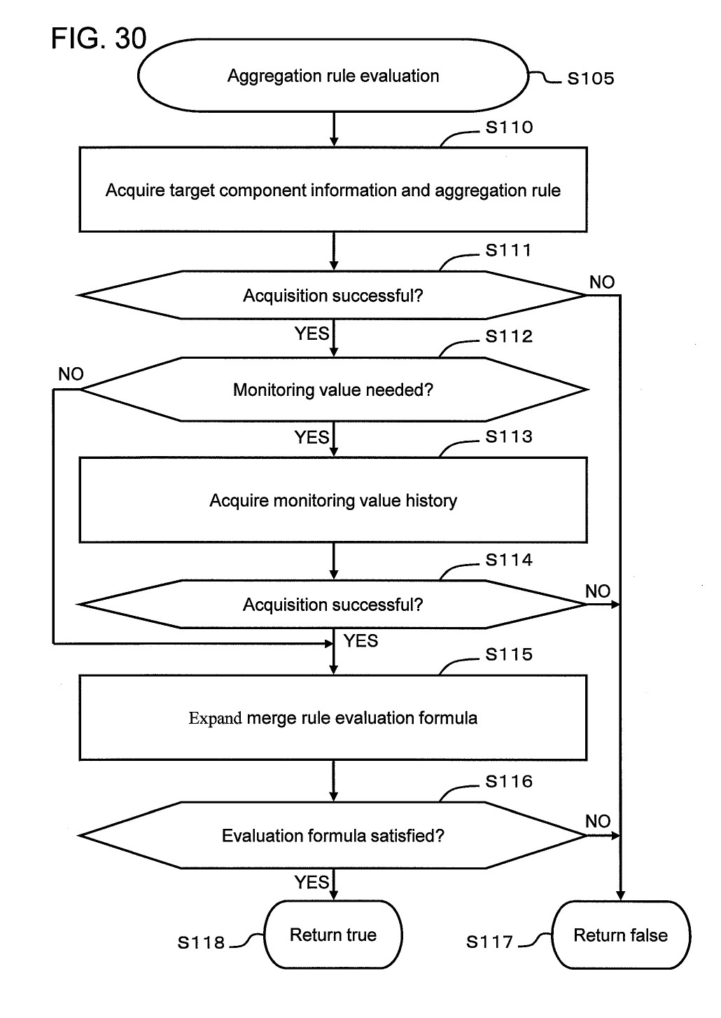

The management computer 10 applies an aggregation rule and performs an evaluation for the combination of entries selected in S104, that is, for the combination of pieces of component information (S105). The process for evaluating the aggregation rule will be described in detail further below using FIG. 30.

The management computer 10 decides whether the aggregation rule evaluation result is true (S106). In a case where the evaluation result is false (S106: NO), the management computer 10 returns to step S104 and acquires another entry combination.

In a case where the aggregation rule evaluation result is true (S106: YES), the management computer 10 determines the advisability of displaying the component information in accordance with a priority configured beforehand for the aggregation rule (S107). Of the two pieces of component information, the management computer 10 only regards the component information, which was acquired using a high-priority management protocol, as a display target, and configures a visible flag value C137 so that component information acquired using a low-priority management protocol is not displayed. The priority of a management protocol may be configured for each piece of component information, or may be configured for each aggregation rule.

FIG. 30 is a flowchart showing the aggregation rule evaluation process (S105). The management computer 10 acquires a combination of component information, which is to be the processing target, and an aggregation rule (S110), and decides whether the acquisition thereof was successful (S111). In a case where the acquisition of the combination of component information and the aggregation rule failed, the management computer 10 returns false as the evaluation result with respect to the flowchart of FIG. 29 (S117). This is because an evaluation cannot be performed when the required information is not obtainable.

In a case where the acquisition of the combination of component information and the aggregation rule was successful (S111: YES), the management computer 10 decides whether a monitoring value history is needed (S112). In a case where the monitoring value history is not needed (S112: NO), the management computer 10 skips steps S113 and S114 and moves to S115.

In a case where the monitoring value history is needed (S112: YES), the management computer 10 acquires the required monitoring value history from the monitoring value history management table T14 (S113). The management computer 10 decides whether the acquisition of the monitoring value history was successful (S114). In a case where the monitoring value history is not able to be acquired despite the fact that it is needed (S114: NO), the management computer 10 returns false as the evaluation result with respect to the flowchart of FIG. 29 (S117).

The management computer 10 expands an evaluation formula for evaluating the aggregation rule (S115), and decides whether the evaluation formula has been satisfied (S116). In a case where it has been decided that the evaluation formula was satisfied (S116: YES), the management computer 10 returns true as the evaluation result with respect to the flowchart of FIG. 29 (S118). In a case where the evaluation formula has not been satisfied (S116: NO), the management computer 10 returns false as the evaluation result with respect to the flowchart of FIG. 29 (S117).

An example of a case in which the “SERVER3BMC” apparatus configuration information has been merged with the “SERVER3” apparatus configuration information will be explained. The apparatus configuration information “SERVER3” comprises a total of three components, for which the component type is fan. These are “FAN3”, “FAN4” and “FAN5”, which belongs to the “SERVER3BMC”.

In S101 of FIG. 29, the management computer 10 refers to the aggregation rule management table T17 shown in FIG. 18, and acquires all the aggregation rules. A case in which processing within the S101 loop is executed for the aggregation rule “AggreegationRule-FAN2” will be explained.

In S102, a component information management table T13A, which corresponds to the target component type “fan”, is used (Refer to FIG. 10). An entry in which “SERVER3” has been configured in the node name C131A is acquired from this management table T13A.

However, the node name C131A of the fifth entry of the fan component information management table T13A has been changed from “SERVER3BMC” to “SERVER3” in accordance with the merge of apparatus configuration information “SERVER3” and apparatus configuration information “SERVER3BMC”.

Therefore, in step S102, a total of three entries, i.e., the third, fourth and fifth entries, are acquired. Since three entries exist, the processing moves to step S104. A case in which an evaluation of the aggregation rule is performed in step S105 for the combination of component information “FAN4” and component information “FAN5” will be explained.

In step S110 of FIG. 30, the management computer 10 acquires the component information of “FAN4” and “FAN5” from the component information management table T13A. Because a monitoring value history is needed in the evaluation of the aggregation rule “AggregationRule-FAN2”, the management computer 10 acquires the monitoring value histories of “FAN4” and “FAN5” from the monitoring value history management table T14A shown in FIG. 13.

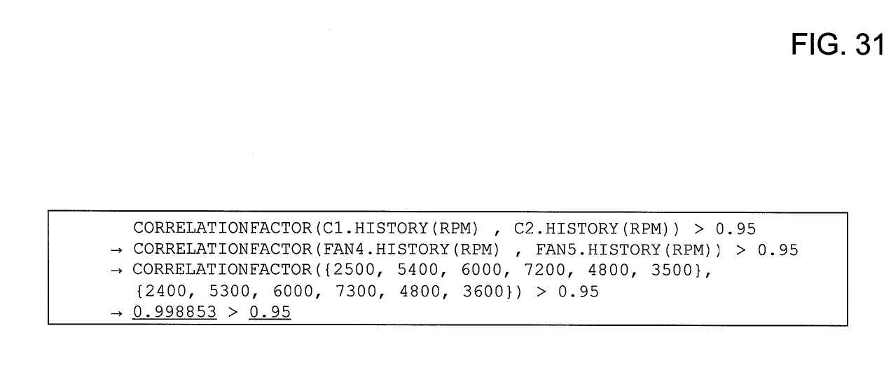

In step S115, the management computer 10 uses the acquired monitoring value histories to create an evaluation formula for the aggregation rule “AggregationRule-FAN2”. The processing flow for the expansion of a specific formula is shown in FIG. 31. Furthermore, it is supposed that the correlation computation algorithm used in the embedded function CORRELATIONFACTOR is the Pearson product-moment correlation coefficient.

Since the evaluation result for the aggregation rule “AggregationRule-FAN2” is true, in step S118, true is returned in the processing of FIG. 29, and the management computer 10 executes step S107.

As shown in the priority C173 of FIG. 18, the protocol priority for the aggregation rule “AggregationRule-FAN2” is configured as WMI>SSH>SNMP>IPMI. Therefore, component information “FAN4” has priority over component information “FAN5”.

As shown in the fourth entry of FIG. 10, the component information “FAN4” has been acquired using the highest priority WMI. As shown in the fifth entry of FIG. 10, the component information “FAN5” has been acquired using the lowest priority IPMI.

The value of the visible flag C137A corresponding to the component information “FAN5” acquired using the lowest priority protocol is changed from True to False. In accordance with this, the component information “FAN5” is not displayed, and the component information “FAN4” becomes the only display target.

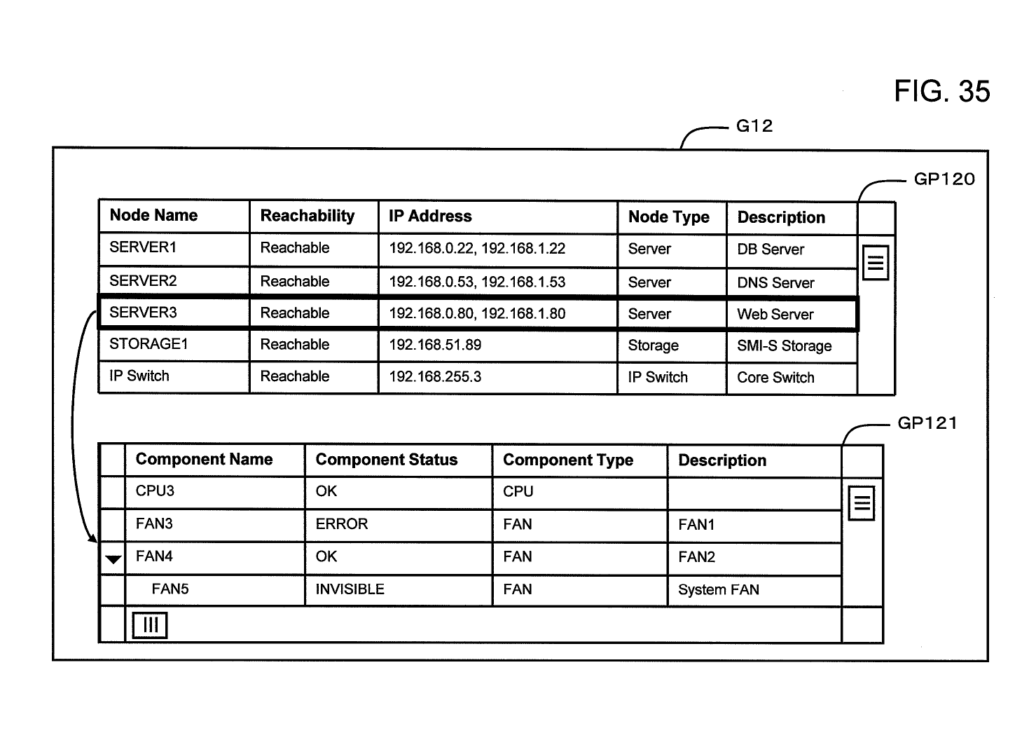

Therefore, the redundant management information created from the same entity, i.e., component information “FAN4” and component information “FAN5”, is deleted from the display. In the apparatus configuration information display screen G12 shown in FIG. 35, the component information “FAN5” is basically concealed beneath the component information “FAN4”, and is displayed when selected by the user.

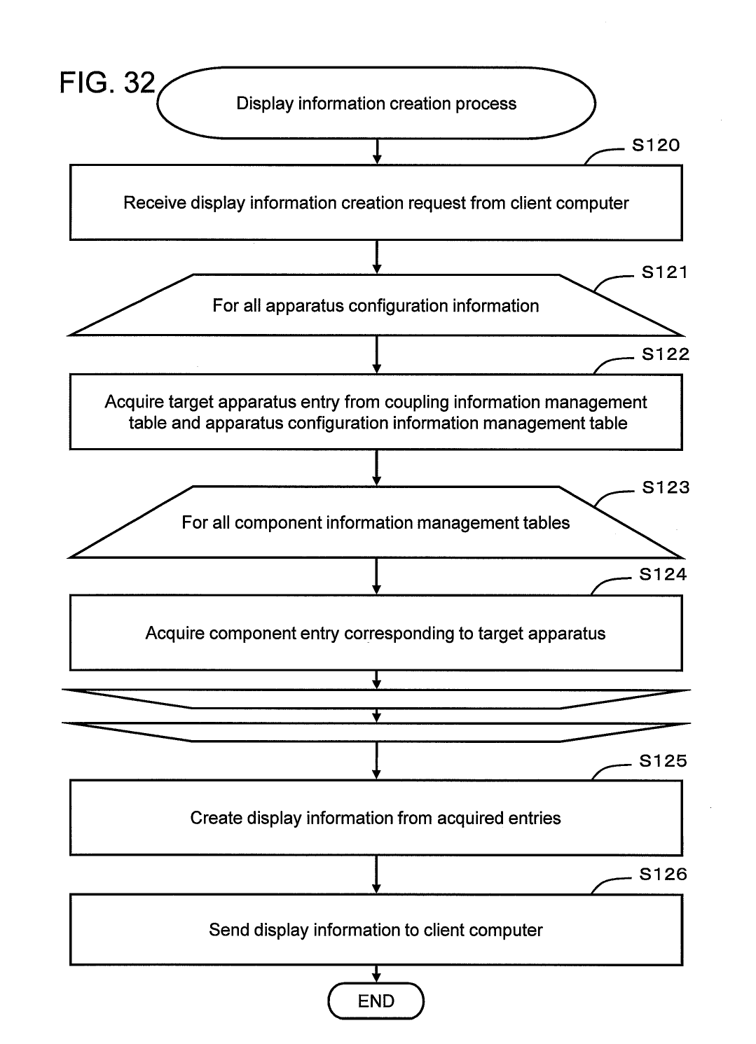

FIG. 32 is a flowchart showing a process for creating display information. The management computer 10 receives a creation request for display information from the client computer 20 (S120). The management computer 10 executes the following steps S122 through S124 for all the apparatus configuration information (S121).

The management computer 10 acquires the entries for the target apparatus (more precisely, the apparatus configuration information that constitutes the target) from the coupling information management table T10 shown in FIG. 7 and the apparatus configuration information management table T12 shown in FIG. 9 (S122). The management computer 10 acquires the entries corresponding to the target apparatus from all of the component information management tables T13 shown in FIGS. 10 through 12 (S123). All of the component information for the target apparatus is acquired for each target apparatus.

The management computer 10 creates the display information (S125), and sends the display information to the client computer 20 (S126). The client computer 20 displays the display information on the user interface device 24.

FIG. 35 is an apparatus configuration information display screen G12, which is the display result of the display information. The screen G12 comprises a node display area GP120 showing information related to the nodes, and a component display area GP121, which displays the information related to the components comprising a node.

When the user selects any node in the node display area GP120, the information of the components comprising this selected node is displayed in list form in the component display area GP121. Duplicate component information is not displayed unless selected by the user.

Because this example is configured as described hereinabove, it achieves the following effects. In this example, duplicate apparatus configuration information originating from the same apparatus is detected and managed as a single piece of apparatus configuration information, and, in addition, duplicate component information originating from the same apparatus is also managed as the single piece of component information. Therefore, the total number of pieces of information to be managed can be reduced, making it possible to efficiently manage an information processing system in which multiple apparatuses corresponding to multiple management protocols exist.

In this example, duplicate apparatus configuration information can be detected automatically on the basis of the merge rule, making it possible for the administrator to save time and trouble. In addition, in this example, since the advisability of a merge rule-based decision result is checked on the basis of an essential requirement rule, the reliability of a decision result can be maintained.

In this example, a check of the combination of apparatus configuration information selected by the user is performed in accordance with the essential requirement rule. Therefore, human error on the part of the user can be prevented, making it possible to enhance usability and reliability.

In this example, a first decision rule based on static unique information, such as a system GUID, and a second decision rule based on a monitoring value history are used as merge rules. In addition, subsequent to making a decision based on the first decision rule, a decision is made based on the second decision rule. This makes it possible to efficiently make highly accurate decisions in this example.

In this example, a decision based on unique information, which is relatively simple to process, and, in addition, is highly accurate, is executed first, and after that, a decision based on monitoring information, which places a big load on arithmetic processing, is executed. As a result of this, a decision, which uses unique information, can be preferentially executed in this example, making it possible to efficiently make a decision with a high degree of accuracy.

In this example, a merge rule-based decision result is checked on the basis of an essential requirement rule. Therefore, it is possible to prevent a decision error. In addition, in this example, an essential requirement rule-based check is also performed for the result of a manual selection by the user. Therefore, a human error on the part of the user can be prevented, making it possible to enhance management reliability.

In this example, only prescribed component information of multiple component information originating from the same apparatus is displayed, but component information other than this is stored rather than being deleted. Therefore, even in a case where a failure has occurred with respect to a management protocol related to the prescribed component information, the system can be managed on the basis of component information in accordance with another management protocol, making the realization of a failsafe possible.

### Example 2

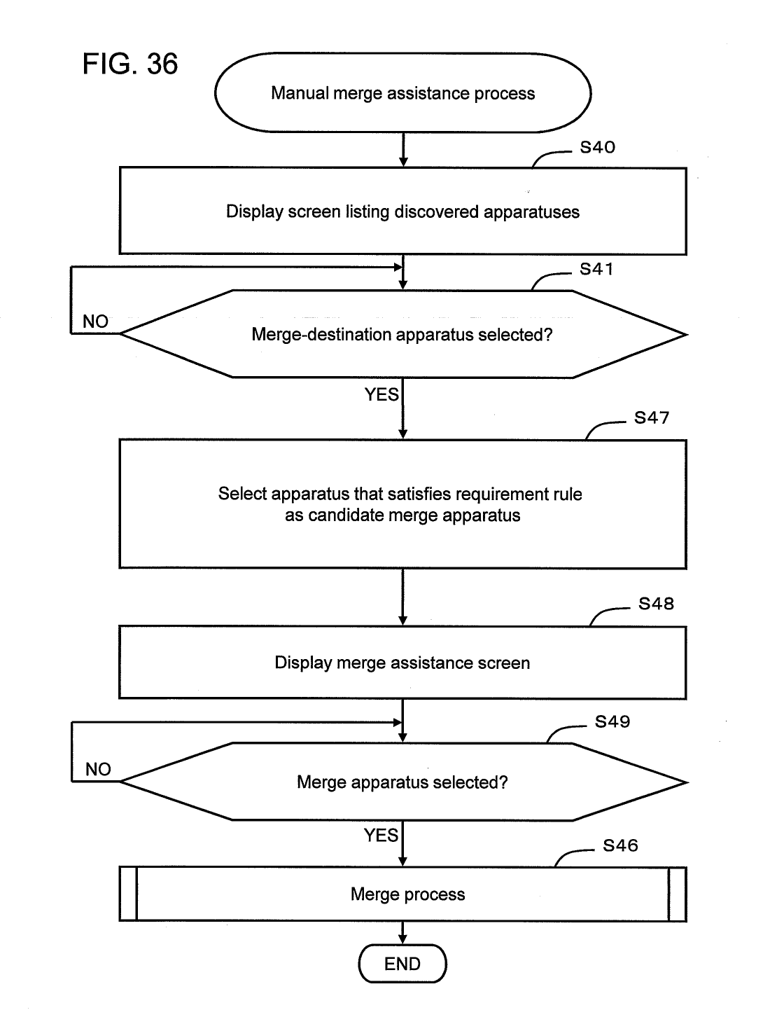

A second example will be explained by referring to FIG. 36. Since this example is equivalent to a variation of the first example, the explanation will focus on the difference with the first example. In this example, in a case where the user selects a target apparatus combination manually, a merged apparatus, which satisfies the essential requirement rule with a merge-destination apparatus, is automatically selected and provided to the user at the point in time at which the user selects the merge-destination apparatus.

The management computer 10 creates the discovered apparatus listing screen G10 shown in FIG. 33, and sends this screen G10 to the client computer 20 for display (S40). The user selects one apparatus that will constitute the merge-destination apparatus from the screen G10, and operates the Merge button (S41).

When the merge-destination apparatus is selected (S41: YES), the management computer 10 respectively evaluates requirement rules for a combination of the merge-destination apparatus and each of the other apparatuses, and selects the apparatus that satisfies the essential requirement rule as the merged apparatus candidate (S47).

The management computer 10 creates the merge support screen G11 shown in FIG. 34, and displays this screen G11 on the user interface device 24 of the client computer 20 (S48). The point that differs with the first example is the fact that only an apparatus, which has previously been confirmed to satisfy the essential requirement rule, is displayed in the display area GP111.

The management computer 10 decides whether a merged apparatus has been selected by the user (S49). In a case where the merged apparatus has been selected (S49: YES), the management computer 10 executes the merge process (S46).

Configuring this example like this also achieves the same effects as the first example. In addition, in this example, when the user selects one apparatus, all other apparatuses that satisfy the essential requirement rule with this apparatus are selected and provided, thereby enabling the user to select a desired apparatus from among apparatuses that are known to satisfy the essential requirement rule. This enhances user convenience.

Furthermore, the present invention is not limited to the embodiment described hereinabove. A so-called person having ordinary skill in the art could conceive of another configuration for achieving the objects of the present invention by changing or deleting a portion of the configuration described in this embodiment, or adding a new configuration. This configuration is also included within the scope to the present invention.

This embodiment can be expressed as a computer program as follows.

Expression 1. A computer program for causing a computer to function as a management computer for managing an information processing system comprising multiple apparatuses, the computer program causing the computer to execute:

a first step for using multiple different management protocols to acquire and store management information of each of the management protocols from each of the apparatuses;

a second step for identifying multiple pieces of apparatus configuration information acquired from the same apparatus of the respective apparatuses by comparing each piece of apparatus configuration information obtained from each of the pieces of management information, and collectively managing these multiple pieces of identified apparatus configuration information as a single piece of apparatus configuration information; and

a third step for identifying multiple pieces of component information related to the same component from among component information included in the multiple pieces of apparatus configuration information identified as having been acquired from the same apparatus, and correspondingly managing these identified multiple pieces of component information.

### REFERENCE SIGNS LIST

1, 10 Management computer
2, 20 Client computer
3, 30 Server computer
40 Storage apparatus
50 Network apparatus
60 Other apparatus

1. A system management apparatus for managing an information processing system including multiple apparatuses, comprising:
a management information acquisition part for using multiple different management protocols to acquire management information for each of the management protocols from each of the apparatuses;
an apparatus configuration information management part for identifying multiple pieces of apparatus configuration information acquired from the same apparatus among the respective apparatuses by comparing apparatus configuration information obtained from the respective pieces of management information, and collectively managing these identified multiple pieces of apparatus configuration information as a single piece of apparatus configuration information; and
a component information management part for identifying multiple pieces of component information related to the same component from among component information included in the multiple pieces of apparatus configuration information identified as having been acquired from the same apparatus, and managing these identified the multiple pieces of component information after associating these with each other.

2. A system management apparatus according to claim 1, wherein
the apparatus configuration information management part comprises an automatic mode, and
the apparatus configuration information management part operating in accordance with the automatic mode identifies multiple pieces of apparatus configuration information acquired from the same apparatus among the respective apparatuses by comparing the respective pieces of apparatus configuration information on the basis a merge rule pre-stored in a merge rule management table.

3. A system management apparatus according to claim 2, wherein the merge rule comprises:
a first decision rule, which, in a case where one piece of unique information, which is included in one piece of apparatus configuration information among the respective pieces of apparatus configuration information, matches the other piece of unique information, which is included in the other piece of apparatus configuration information among the respective pieces of apparatus configuration information, decides that the one piece of apparatus configuration information and the other piece of apparatus configuration information are pieces of apparatus configuration information acquired from the same apparatus; and
a second decision rule, which, in a case where one piece of monitoring information, which is included in one piece of management information among the respective pieces of management information and shows either a performance or a status monitoring result of an apparatus corresponding to the one piece of management information, matches within a prescribed range the other piece of monitoring information which is included in the other piece of management information among the respective pieces of management information and shows either a performance or a status monitoring result of an apparatus corresponding to the other piece of management information, decides that one piece of apparatus configuration information obtained from the one piece of management information and the other piece of apparatus configuration information obtained from the other piece of management information are pieces of apparatus configuration information acquired from the same apparatus.

4. A system management apparatus according to claim 3, wherein the apparatus configuration information management part first identifies multiple pieces of apparatus configuration information obtained from the same apparatus in accordance with the first decision rule, and in a case where an identification is not possible with the first decision rule, identifies multiple pieces of apparatus configuration information acquired from the same apparatus in accordance with the second decision rule.

5. A system management apparatus according to claim 4, wherein the apparatus configuration information management part decides whether or not the respective pieces of apparatus configuration information identified as having been acquired from the same apparatus satisfy an essential requirement rule pre-stored in an essential requirement rule table, and in a case where the respective pieces of apparatus configuration information satisfy the essential requirement rule, decides that the respective pieces of apparatus configuration information have been acquired from the same apparatus.

6. A system management apparatus according to claim 5, wherein
the apparatus configuration information management part comprises a manual mode, and
an essential requirement rule, which must be satisfied in a case where multiple pieces of apparatus configuration information have been acquired from the same apparatus, is pre-configured in an essential requirement rule management table, wherein
the apparatus configuration information management part:
provides a user with a screen for listing the respective pieces of apparatus configuration information when operating in accordance with the manual mode;
decides whether or not multiple pieces of apparatus configuration information selected by the user via the listing screen satisfy the essential requirement rule; and
in a case where the respective pieces of apparatus configuration information selected by the user satisfy the essential requirement rule, determines that the respective pieces of apparatus configuration information have been acquired from the same apparatus.

7. A system management apparatus according to claim 6, comprising a display information creation part for creating display information for outputting to a display device the respective pieces of apparatus configuration information managed by the apparatus configuration information management part.

8. A system management apparatus according to claim 7, wherein the component information management part includes in the display information only prescribed component information among the multiple pieces of component information identified as component information related to the same component.

9. A system management apparatus according to claim 8, wherein
a priority is given beforehand to the each management protocol, and
component information obtained from management information acquired using the highest priority management protocol is selected as the prescribed component information from among the multiple pieces of component information identified as component information related to an identical component.

10. A system management apparatus according to claim 9, wherein other pieces of component information, which have not been selected as the prescribed component information, are held by a component information management table for storing component information.

11. A system management apparatus according to claim 10, wherein the component information management part identifies component information related to the same component by comparing the respective pieces of component information on the basis of a component merge rule pre-stored in a merge rule management table for components, wherein
the component merge rule comprises:
a first component decision rule, which, in a case where one piece of unique information, which is included in one piece of component information among the respective pieces of component information, matches the other piece of unique information, which is included in the other piece of component information among the respective pieces of component information, decides that the one piece of component information and the other piece of component information are pieces of component information related to the same component; and
a second component decision rule, which, in a case where one piece of component monitoring information, which is included in one piece of management information among the respective pieces of management information and shows either a performance or a status monitoring result of a component corresponding to the one piece of management information, matches within a prescribed range the other piece of component monitoring information, which is included in the other piece of management information of the respective pieces of management information and shows either a performance or a status monitoring result of a component corresponding to the other piece of management information, decides that one piece of component information obtained from the one piece of management information and the other piece of component information obtained from the other piece of management information are pieces of component information related to the same component.

12. A system management apparatus according to claim 11, wherein the component information management part uses the first component decision rule preferentially to the second component decision rule.

13. A system management apparatus according to claim 8, wherein other piece of component information other than the prescribed piece of component information is stored rather than deleted.

14. A system management method for managing an information processing system including multiple apparatuses by means of a management computer, with this management computer having: a microprocessor; a prescribed computer program executed by the microprocessor; and a communication interface part for the microprocessor to access the respective apparatuses,
the system management method, with the microprocessor executing the prescribed computer program, executing:
a first step of using multiple different management protocols to acquire management information for each of the management protocols from the each apparatus and store the acquired information;
a second step of identifying multiple pieces of apparatus configuration information acquired from the same apparatus among the respective apparatuses by comparing the respective pieces of apparatus configuration information obtained from the respective pieces of management information, and collectively managing these identified multiple pieces of apparatus configuration information as a single piece of apparatus configuration information; and
a third step of identifying multiple pieces of component information related to the same component and managing these identified multiple pieces of component information of the component information included in the multiple pieces of apparatus configuration information identified as having been acquired from the same apparatus after associating these pieces of information with each other.

15. A system management method according to claim 14, wherein
the second step comprises a manual mode and an automatic mode, and
in a case where the automatic mode has been selected:
multiple pieces of apparatus configuration information acquired from the same apparatus are identified from among the respective apparatus by comparing the respective pieces of apparatus configuration information on the basis of a merge rule pre-stored in a merge rule management table, and
in a case where the manual mode has been selected:
a screen listing the respective pieces of apparatus configuration information is provided to a user;
a decision is made as to whether multiple pieces of apparatus configuration information selected by the user by way of the listing screen satisfy an essential requirement rule, which must be satisfied in a case where multiple pieces of apparatus configuration information have been acquired from the same apparatus; and
a determination that the respective pieces of apparatus configuration information have been acquired from the same apparatus is made in a case where the respective pieces of apparatus configuration information selected by the user satisfy the essential requirement rule.
